(19) United States
(12) Patent Application Publication
(10) Pub. No.: US 2025/0334553 A1
(43) Pub. Date: Oct. 30, 2025

(54) Liquid Chromatography Integrated Mobile Phase Pre-Heating Apparatus and Associated Systems and Methods

(71) Applicant: CEM Corporation, Matthews, NC (US)

(72) Inventors: Colin L. Simpson, Monroe, NC (US); David E. Deese, Indian Trail, NC (US)

(21) Appl. No.: 19/184,272

(22) Filed: Apr. 21, 2025

Related U.S. Application Data
(60) Provisional application No. 63/638,975, filed on Apr. 26, 2024.

(51) Int. Cl. G01N 30/30; G01N 30/02

(52) U.S. Cl. CPC G01N 30/30; G01N 2030/027; G01N 2030/3046; G01N 2030/3053; G01N 2030/3084

(57) ABSTRACT

A liquid chromatography column oven capable of heating a mobile phase at a preparative scale prior to sample injection in the mobile phase can include a heat source configured to generate heat; and a heat transfer assembly. The heat transfer assembly can include a heat transfer structure formed of a thermally conductive material in a conductive heat transfer relationship with the heat source and including a recessed pathway in a surface of the heat transfer structure. The heat transfer assembly can further include tubing also formed of a thermally conductive material. A first portion of an exterior surface of the tubing is in a conductive heat transfer relationship with the recessed pathway of the heat transfer structure, and a second portion of the exterior surface of the tubing is in a conductive heat transfer relationship with the heat source.

### CROSS-REFERENCE TO PRIORITY APPLICATION

This application claims the benefit of pending U.S. Provisional Patent Application No. 63/638,975, filed Apr. 26, 2024, the entire disclosure of which is hereby incorporated by reference in its entirety.

### FIELD

The present disclosure relates generally to liquid chromatography systems and associated methods, and in particular to a liquid chromatography column oven having an integrated mobile phase pre-heating apparatus and associated mobile phase pre-heating systems and methods.

### BACKGROUND

Chromatography methods can be used to separate, identify, and quantify specific components in a mixture or sample. For example, liquid chromatography (LC) is a technique used for analytical or preparative separation of a liquid-phase sample (e.g., a mixture of different chemical compounds) into its constituent components.

In high performance liquid chromatography (HPLC), a sample including different components is injected into a flowing mobile phase (typically one or more solvents) and pumped through a column containing media (i.e., stationary phase) that is often functionalized with various surface chemistries. The components in the sample interact differently with the stationary phase (e.g., exhibit different retention with/affinity for the stationary phase) so that the sample is separated into its separate components as the sample flows through the column. For example, components that are strongly retained by the stationary phase travel slowly with the mobile phase, while components that are weakly retained by the stationary phase travel more rapidly. As a result, components of differing compositions become separated from each other as the mobile phase flows through the column.

After exiting the column, the mobile phase passes through a detector. The detector detects the presence of a particular component in the mobile phase exiting the column and generates a signal. The detector can generate a signal proportional to the amount of sample component emerging from the column, allowing for quantitative analysis of the sample components; mark the time of emergence (the retention time), which serves for initial identification of the component; etc. The detector signal can be plotted as a function of time to provide response “peaks” corresponding to the presence and quantities of the components of the sample.

HPLC may be used in analytical separation or in semi-preparative and/or preparative separation. In analytical separation, the components are separated to facilitate their analysis by detection and data acquisition techniques. Analytical separation typically uses relatively small amounts of material, low flow rates (e.g., less than about 2 mL/min), and small inner-diameter (ID) columns (e.g., columns with 4.6 mm ID or smaller), as compared to semi-preparative and/or preparative HPLC.

In contrast, in semi-preparative and/or preparative separation, the sample components are separated to purify or isolate one or more chemical components from the sample, which may be done for further use (e.g., research, synthesis, etc.). To perform a semi-preparative and/or preparative method, a sample is injected into the flowing mobile phase and passes through the column and sample components are separated according to different levels of interaction with the stationary phase. The sample components then pass through the detector, which enables the determination of component identity for purposes of either diverting to waste or diverting to a collection vessel. Semi-preparative and/or preparative separation may be performed on a larger scale using higher flow rates (e.g., ranging from about 4 mL/minute to about 40 mL/minute and higher, e.g., up to about 150 to about 200 mL/min) and larger ID columns (e.g., columns with 9.4/10 mm ID or larger) to purify a large quantity of sample material, as compared to analytical HPLC.

Thus, typically, in semi-preparative and/or preparative HPLC, the sample components are collected after purification, whereas for analytical HPLC, the sample components are simply detected and quantified. Also, semi-preparative and/or preparative HPLC may be performed on a larger scale using a larger quantity of sample material, larger ID columns, and/or higher flow rates, as compared to analytical HPLC.

Temperature control of the column and mobile phase can affect method reproducibility, and the use of elevated temperature conditions can improve peak shape and sample solubility, as well as enable shorter methods as a result of lower backpressures (due to decreased mobile phase viscosity) and higher flow rates.

Analytical liquid chromatography using low flow rates may include integrated active mobile phase pre-heating in a column oven. Chromatography applications with higher flow rates (e.g., semi-preparative and preparative HPLC), however, have conventionally required the use of a separate and dedicated mobile phase heater. This can add significant cost and/or complexity to liquid chromatography configurations, and as a result, the use of elevated temperature conditions is seldom used for lab scale semi-preparative and preparative applications.

Accordingly, there is a need for improved HPLC mobile phase (eluent) pre-heating at the semi-preparative and/or preparative scale.

### SUMMARY OF THE INVENTION

An aspect of the present disclosure relates to an apparatus for heating a flowing liquid in a liquid chromatography system (e.g., a high-performance liquid chromatography, or HPLC, system). The apparatus is integrated within a liquid chromatography column oven and is configured for heating a flowing liquid (e.g., for pre-heating a flowing mobile phase or eluent prior to sample injection into the flowing mobile phase/directing a sample carried by the flowing mobile phase into a chromatography column) at a semi-preparative and/or preparative scale (e.g., wherein one or more sample components are collected after separation).

The liquid chromatography column oven includes a housing defining a column oven interior space. The column oven interior includes a heat source configured to generate heat and a liquid chromatography column (e.g., a column configured for semi-preparative and/or preparative scale liquid chromatography). The column oven interior space also includes an apparatus (e.g., a heat transfer assembly) formed of a thermally conductive material and positioned within the column oven interior in a conductive heat transfer relationship with the heat source. The heat transfer assembly is positioned downstream from, and in fluid communication with, a liquid source (e.g., a mobile phase or eluent source/pump configured to direct flowing mobile phase from the mobile phase source into the heat transfer assembly) and also upstream from, and in fluid communication with, the column.

More specifically, the heat transfer assembly includes at least one heat transfer structure formed of a thermally conductive material (e.g., at least one, and in some embodiments, two, heat transfer plates) in a conductive heat transfer relationship with the heat source. The heat transfer structure (e.g., a heat transfer plate) also includes at least one recessed pathway (and in some embodiments at least two recessed pathways) in a surface of the heat transfer structure.

The heat transfer assembly further includes at least one tubing (and in some embodiments, at least two tubings) also formed of a thermally conductive material. The tubing includes an inlet in fluid communication with the liquid source (e.g., the mobile phase or eluent source/pump configured to direct flowing mobile phase from the mobile phase source into the tubing) and an outlet in fluid communication with the column (e.g., to direct the mobile phase flowing through the tubing into the column).

The heat transfer structure and the tubing of the heat transfer assembly are configured so that at least a first portion of an exterior surface of the tubing is in a conductive heat transfer relationship with the recessed pathway of the heat transfer structure, and at least a second portion of the exterior surface of the tubing is in a conductive heat transfer relationship with the heat source. The same heat source can accordingly provide heat to the heat transfer structure for transfer to the first portion of the exterior surface of the tubing and to a mobile phase flowing through the tubing; and also provide heat to the second portion of the exterior surface of the tubing for transfer to the mobile phase flowing through the tubing.

Another aspect of this disclosure relates to a method of heating a flowing liquid in a chromatography column. More specifically, this disclosure also relates to a method of pre-heating a flowing mobile phase (e.g., eluent) prior to initiating liquid chromatography of a sample carried by the mobile phase (e.g., prior to injecting a liquid chromatography sample into the mobile phase). The method can pre-heat the flowing mobile phase at a semi-preparative and/or preparative scale in liquid chromatography (e.g., in HPLC) using the heat transfer assembly described herein.

A further aspect of this disclosure is the provision of a liquid chromatography system including a column oven having an integrated mobile phase pre-heating apparatus (e.g., the heat transfer assembly) as described herein. A further aspect of this disclosure relates to a method of conducting liquid chromatography (e.g., at a semi-preparative and/or preparative scale) using a liquid chromatography system, wherein the liquid chromatography system includes a column oven including the integrated mobile phase pre-heating apparatus (e.g., the heat transfer assembly) as described herein. The method may include pre-heating a mobile phase (e.g., eluent) flowing through the integrated mobile phase pre-heating apparatus (e.g., the heat transfer assembly) prior to initiating liquid chromatography of a sample carried by the mobile phase (e.g., prior to injecting a liquid chromatography sample into the mobile phase), also as described herein.

A benefit of the present disclosure is the ability to use the same heat source both to heat the mobile phase flowing through the system (e.g., to conductively pre-heat the mobile phase flowing through the tubing of the heat transfer assembly before sample injection); and also to indirectly (e.g., convectively) heat the interior of column oven (and the column, including a stationary phase within the column, before, during, and after sample injection), for example, using a fan located in the column oven configured to circulate radiant heat provided by the heat source.

In addition, due to convective heating principles, the temperature of the heat source will be higher than the temperature of the interior of the column oven (and/or higher than a column oven temperature set point). Without being bound by any explanation or theory of the invention, it is currently believed that the higher temperature of the heat source as compared to the temperature of the interior of the column oven (and/or the column oven temperature set point), and also the conductive heating of the tubing by the heat source, can improve heat transfer to the flowing mobile phase and thus can advantageously be used to minimize tubing length (and therefore tubing internal volume) in the heat transfer assembly. The ability to minimize the required tubing length may facilitate integration of the heat transfer assembly in the interior of the column oven, which can eliminate the need for a separate and dedicated mobile phase heater for semi-preparative and preparative applications. Integration of the heat transfer assembly in the interior of the column oven can reduce cost and complexity of the liquid chromatography system and facilitate the use of elevated temperature conditions (e.g., up to about 70° C.) for semi-preparative and preparative applications. Minimization of the tubing internal volume may also help reduce extra column band broadening.

The foregoing summary provides a few brief examples and is not exhaustive, and the present invention is not limited to the foregoing examples. Various other features, aspects, and advantages of the present invention will be evident from the following description and accompanying figures.

### BRIEF DESCRIPTION OF THE DRAWINGS

The drawings discussed below are schematic, and features depicted therein may not be drawn to scale. The drawings are provided as examples. The present invention may be embodied in many different forms and should not be construed as limited to the examples depicted in the drawings.

FIG. 1 is a high-level diagram of a liquid chromatography system that can be used to facilitate pre-heating a mobile phase prior to initiating semi-preparative and/or preparative liquid chromatography in accordance with an embodiment of this disclosure.

FIG. 2 is a front right pictorial view of a liquid chromatography column oven of the liquid chromatography system of FIG. 1, wherein a housing of the column oven is partially cut away to schematically depict a heat transfer assembly in a conductive heat transfer relationship with a heat source in the column oven for pre-heating a flowing mobile phase, in accordance with an embodiment of this disclosure.

FIG. 3 is a portion of a cross-sectional view taken along line 3-3 of FIG. 2, in accordance with an embodiment of this disclosure.

FIG. 4 is a front right pictorial view of the liquid chromatography column oven of FIG. 2 depicting a partially assembled view of the heat transfer assembly and the heat source, in accordance with an embodiment of this disclosure.

FIG. 5 is a front right pictorial view of the liquid chromatography column oven of FIG. 2 further depicting a chromatography column in the column oven, in accordance with an embodiment of this disclosure.

FIG. 6 is a front isolated view of the heat transfer assembly, in accordance with an embodiment of this disclosure.

FIG. 7 is an isolated view of the opposite side of the heat transfer assembly of FIG. 6, in accordance with an embodiment of this disclosure.

FIG. 8 is an isolated view of a heat transfer plate of the heat transfer assembly of FIG. 7 and depicts a recessed pathway in a surface of the heat transfer plate, in accordance with an embodiment of this disclosure.

FIG. 9 is an isolated view of another heat transfer plate of the heat transfer assembly of FIG. 7 and depicts other recessed pathways in a surface of the other heat transfer plate, in accordance with an embodiment of this disclosure.

FIG. 10 is an isolated view of the heat transfer plate of FIG. 8 further depicting a section of a tubing located in the recessed pathway, in accordance with an embodiment of this disclosure.

FIG. 11 is an isolated view of the heat transfer plate of FIG. 9 further depicting sections of tubings located in the other recessed pathways, in accordance with an embodiment of this disclosure.

FIG. 12 is an isolated exploded view of the heat transfer assembly of FIG. 7, in accordance with an embodiment of this disclosure.

FIG. 13 is an isolated view of a portion of the heat transfer assembly of FIG. 7, in accordance with an embodiment of this disclosure.

FIG. 14 is an isolated view of another portion of the heat transfer assembly of FIG. 7, in accordance with an embodiment of this disclosure.

FIG. 15 depicts a flow diagram for a method that can be performed at least partially by a controller of the heat source of the liquid chromatography column oven of FIGS. 2 and 4-5, in accordance with an embodiment of this disclosure.

### DETAILED DESCRIPTION

Examples of embodiments are disclosed in the following. The present invention may, however, be embodied in many different forms and should not be construed as limited to the embodiments set forth herein. For example, features disclosed as part of one embodiment or example can be used in the context of another embodiment or example to yield a further embodiment or example. As another example of the breadth of this disclosure, it is within the scope of this disclosure for one or more of the terms “substantially,” “about,” “approximately,” and/or the like, to qualify each of the adjectives and adverbs of the Detailed Description section of this disclosure, as discussed in greater detail below.

The present disclosure is directed to an apparatus for heating a flowing liquid in a liquid chromatography (LC) system (e.g., a high-performance liquid chromatography or HPLC system, or other types of chromatography systems involving the flow of a sample-bearing mobile phase through a column including packing or a bed supporting a stationary phase). As discussed in more detailed herein, the apparatus for heating the flowing liquid in the LC system is integrated in a liquid chromatography column oven (column heater) of the LC system and is configured for heating the flowing liquid (e.g., for pre-heating a flowing mobile phase or eluent prior to sample injection/directing a sample carried by the mobile phase into a chromatography column) at a preparative scale (e.g., wherein one or more sample components are collected after separation).

As used herein, the terms “semi-preparative scale” and/or “preparative scale” refer to liquid chromatography systems, columns, devices, methods, etc. in which one or more components of a sample analyzed using liquid chromatography may be collected for downstream use (study, reaction, etc.). Also as used herein, the term “semi-preparative scale” and/or “preparative scale” refer to liquid chromatography systems, columns, devices, methods, etc. using mobile phase flow rates ranging from about 4 mL/minute to about 200 mL/minute, for example from about 4 mL/minute to about 150 mL/minute, as another example from about 4 mL/minute to about 100 mL/minute, as another example from about 4 mL/minute to about 80 mL/minute, as another example from about 4 mL/minute to about 40 mL/minute, for example, from about 4 mL/minute to about 14 mL/minute, and as another example from about 15 mL/minute to about 40 mL/minute; and/or using larger inner diameter (ID) columns (e.g., columns larger than or about 9.4/10 mm ID) to purify a large quantity of sample material, as compared to analytical HPLC.

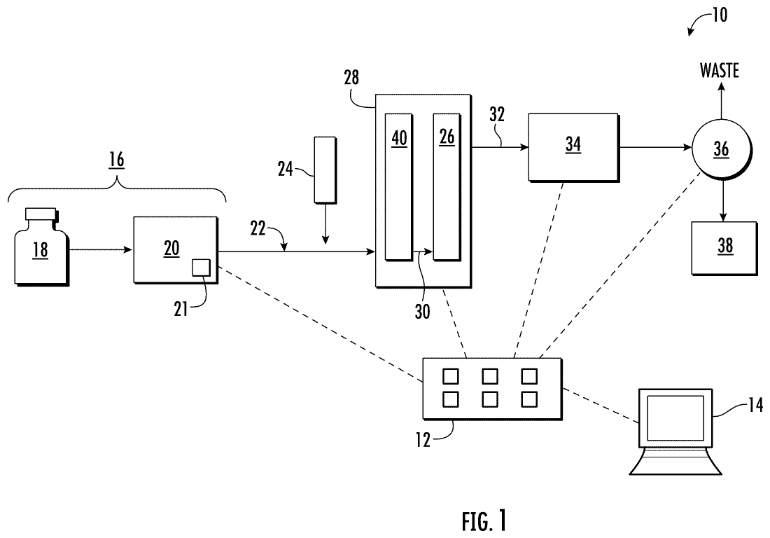

FIG. 1 is a block diagram schematically depicting an exemplary liquid chromatography system 10 (e.g., a HPLC system) configured to facilitate, for example, mobile phase pre-heating within a liquid chromatography column oven (e.g., configured to integrate mobile phase pre-heating within a semi-preparative and/or preparative scale HPLC column oven) in accordance with embodiments of the present disclosure. The system 10 is first described below at a high level and more detailed descriptions follow the initial overview.

In the example depicted in FIG. 1, the system 10 can include a system controller or computer 12 (e.g., processor) in communication with a graphical user interface device 14 for receiving input parameters and displaying system information to an operator. The system controller 12 communicates with a mobile phase supply system (e.g., a solvent manager) 16 including a solvent (eluent) source (e.g., reservoir) 18 in fluid communication with a pump 20 to provide one or more solvents for a mobile phase. The pump 20 can include a pressure sensor 21, as known in the art and as discussed in more detail herein. The solvent(s) are pumped along a mobile phase flow path 22 in fluid communication with a sample injection valve 24. The mobile phase supply system 16 and the sample injection valve 24 are upstream from and in fluid communication with a heat transfer assembly 40 in accordance with embodiments of the present invention (also referred to as a heat transfer apparatus 40), as schematically depicted by flow path 22, wherein the heat transfer assembly 40 is configured to heat a liquid (e.g., a mobile phase) flowing through the heat transfer assembly 40, as discussed in more detail herein. The heat transfer assembly 40 is upstream from and in fluid communication with a chromatographic column 26 (e.g., a column configured for liquid chromatography at the semi-preparative and/or preparative scale), as schematically depicted by a flow path 30. Each of the heat transfer assembly 40 and the column 26 are located in a liquid chromatography column oven 28.

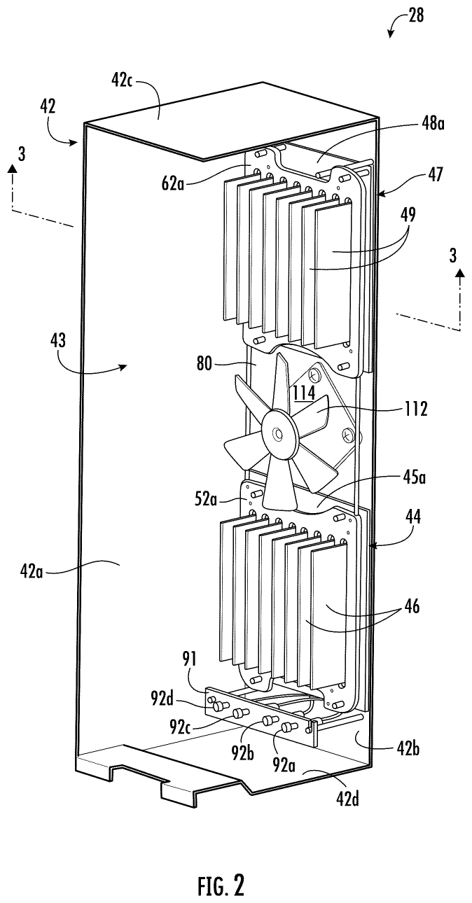

More specifically as described in more detail herein (e.g., with reference to FIGS. 2-14), the heat transfer assembly 40 is integrated within the interior of the column oven 28 and is configured to heat (e.g., pre-heat) a flowing liquid (e.g., a mobile phase or eluent) to be used in a liquid chromatography method (e.g., for pre-heating the mobile phase before injecting a sample to be analyzed at a semi-preparative and/or preparative scale into the flowing mobile phase). Accordingly, in embodiments of the present disclosure, prior to sample injection, the mobile phase continues along flow path 22 into the heat transfer apparatus 40 and along flow path 30 into the column 26 (e.g., via a chromatography column inlet port in fluid communication with a heat transfer assembly 40, such as depicted in FIGS. 2-14 and as described in more detail below).

The chromatographic column 26 is upstream from and is coupled to (in fluid communication with) a detector 34 via a flow path 32. In accordance with embodiments of the present disclosure, again prior to sample injection into the flowing mobile phase, the mobile phase flows through column 26 and continues along flow path 32 to a detector 34. After passing through the detector 34, the mobile phase may be directed to a diverter valve 36, which can be used to direct the system flow to a waste port.

Once the mobile phase is pre-heated as described herein, a sample can be injected into the mobile phase upstream from the column oven 28 at the injection valve 24. The sample can be provided from a sample reservoir such as a vial or other container that holds a volume of the sample. As noted herein, the injection valve 24 is in fluid communication with the column oven 28 and the heat transfer assembly as depicted by flow path 22, and with the column 26 within the column oven 28 as depicted by flow path 30, and the mobile phase including the sample continues along flow path 22 into the heat transfer assembly 40 and along flow path 30 from the heat transfer assembly 40 into the column 26 (e.g., again via the chromatography column inlet port in fluid communication with the heat transfer assembly 40, such as depicted in FIGS. 2-14 and as described in more detail below).

The mobile phase including the sample flows through column 26 and continues along flow path 32 to the detector 34, and the detector 34 provides a signal(s) to the system controller (e.g., processor) 12 that is responsive to various components detected in the eluent from the column 26. After passing through the detector 34, when used for fraction collection, the system flow can be directed to a diverter valve 36, which can be used to direct the system flow to one or more collection vessels 38; alternatively, in some embodiments, the system flow can be diverted to a waste port.

The controller 12 can be operatively associated with, for example, numerous components of the system and can provide signals to and receive signals (e.g., electrical signals) from the graphical user interface device 14, mobile phase supply system 16, column oven 28 (e.g., signals to and/or from a temperature sensor, a heat source and/or other components located within the column oven 28 as described in more detail herein), detector 34, and diverter valve 36. Communication paths (e.g., electrical signal communication paths) between the controller 12, graphical user interface device 14, mobile phase supply system 16, column oven 28 (e.g., a temperature sensor, a heat source, and/or other components located within the column oven 28 located within the column oven 28), detector 34, and diverter valve 36 are schematically depicted with dashed lines in FIG. 1.

The controller 12 can include one or more computers, computer data storage devices, programmable logic devices (PLDs) and/or application-specific integrated circuits (ASIC). A suitable computer can include one or more of each of a central processing unit (CPU) or processor, integrated circuits or memory, user interface (e.g., graphical user interface 14), peripheral or equipment interface for interfacing with other electrical components of the system by way of suitable signal communication paths. Methods of this disclosure can be controlled (e.g., at least partially controlled) in response to the execution of computer-based algorithms operatively associate with the controller 12. The controller 12 is schematically represented as a rectangle identified by numeral 12 and other components or features mentioned in this paragraph are schematically represented by squares positioned within the rectangle identified by numeral 12 in FIG. 1.

The structure and operation of various types of HPLC systems and of individual components typically used in such systems (e.g., computer/controller, mobile phase supply system, injection valve, chromatographic column, detector, diverter valve, etc.) are generally understood by persons skilled in the art and thus are not described in detail herein.

Turning now to FIGS. 2 and 4-5, FIGS. 2 and 4-5 are front right pictorial views of an exemplary liquid chromatography column oven 28 (also referred to herein as “column oven”) according to embodiments of the present disclosure. FIGS. 2 and 4-5 schematically depict the column oven 28 as including a housing 42 extending around an interior space 43 (also referred to herein as the oven chamber) of the column oven 28. The housing 42 can include at least one or more walls (e.g., at least one side wall, a top wall, and a bottom wall). The specific design and shape of the column oven is not limited and in certain embodiments can have a generally rectangular shape including left, right, front, and back side walls, a top wall, and a bottom wall.

As schematically depicted in FIGS. 2 and 4-5, the housing 42 is partially cut away for ease of reference to the column oven interior and various components that can be present in the interior of the column oven in accordance with embodiments of the present disclosure. For example, each of FIGS. 2 and 4-5 schematically depict a left side wall 42a, a back side wall 42b, a top wall 42c, and a bottom wall 42d, wherein a front side wall and right side wall of the housing 42 have been removed for ease of reference to the interior space 43 of the column oven 28.

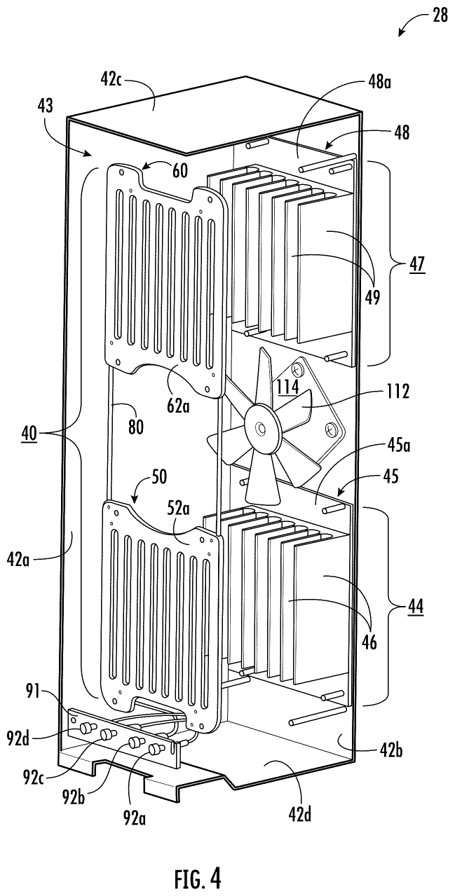

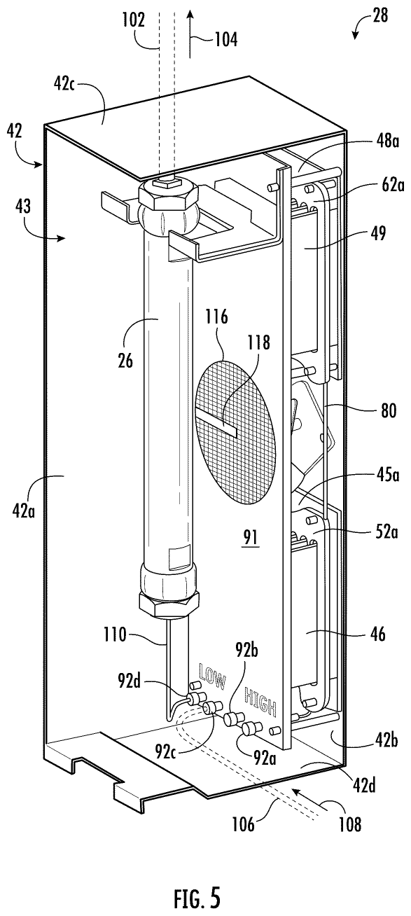

More specifically, FIG. 2 schematically depicts the heat transfer assembly 40 (see FIG. 4) in a conductive heat transfer relationship with at least one heat source (e.g., with a heat source 44 and a heat source 47, also referred to herein as lower heat source 44 and upper heat source 47; see FIG. 4), wherein both the heat transfer assembly 40 and the heat sources 44 and 47 are located in the interior space 43 of the column oven 28. FIG. 4 schematically depicts a partially assembled view of the heat transfer assembly 40 and the heat sources 44 and 47; and FIG. 5 is the same as FIG. 2 except schematically depicting additional components of the column oven 28 (e.g., a chromatography column 26 in the interior space 43 of the column oven 28, etc.) as described herein.

As schematically depicted in FIGS. 2 and 4-5, the heat source 44 may include a base 45 (e.g., a plate-like base) having an inner surface 45a and opposite outer surface. The inner surface 45a of the base 45 faces the heat transfer assembly 40 (e.g., at least a portion of the inner surface 45a of the base 45 is in direct contact with at least a portion of the heat transfer assembly 40) and the outer surface of the base 45 faces an interior surface of the rear wall 42b of the column oven 28 (e.g., at least a portion of the outer surface of the base 45 is mounted to the interior surface of rear wall 42b).

Similarly, in some embodiments, again such as schematically depicted in FIGS. 2 and 4-5, the heat source 47 may include a base 48 (e.g., a plate-like base) having in inner surface 48a and an opposite outer surface. The inner surface 48a of the base 48 faces the heat transfer assembly 40 (e.g., at least a portion of the inner surface 48a of the base 48 is in direct contact with at least a portion of the heat transfer assembly 40) and the outer surface of the base 48 faces an interior surface of the rear wall 42b of the column oven 28 (e.g., at least a portion of the outer surface of the base 48 is mounted to the interior surface of rear wall 42b).

The base 45 and base 48 may be mounted to the interior surface of the rear wall 42b using any suitable mechanical fasteners (e.g., screws, posts, etc.). At least a portion of the heat sources 44 and/or 47 (e.g., plates 45 and/or 48 of heat sources 44 and/or 47, respectively) can be configured to receive an electric power input (electrical energy), such as an electric current and/or voltage, and to convert the electric power input (e.g., electric current and/or voltage) to thermal energy to generate heat which can be transferred (e.g., as conductive and/or radiant heat transfer). In some embodiments, the heat sources 44 and/or 47 can generate thermal energy sufficient to convectively heat the interior of the column oven as described herein to a temperature up to about 80° C., for example from about 25° C. to about 70° C.

The heat source 44 can include a plurality of fins 46 extending from one of the opposite surfaces (e.g., extending from the inner surface 45a of the base 45 facing the heat transfer assembly 40). Similarly, the heat source 47 can include a plurality of fins 49 extending from one of the opposite surfaces (e.g., extending from the inner surface 48a of the base 48 facing the heat transfer assembly 40). Heat generated by plates 45 and/or 48 may be conductively transferred to fins 46 and/or 49, respectively.

In some embodiments, the heat source 44 and/or 47 may be or include an electrical resistance heater (e.g., to generate resistive heat), a Peltier element, etc. Electrical resistance heaters and Peltier elements are conventional and known in the art.

The heat transfer assembly 40 includes one or more heat transfer structures (e.g., one, two, or more heat transfer structures) having opposite surfaces and one or more (e.g., one, two, three or more) recessed pathways (e.g., grooves, flutes, channels, etc.) in one of the opposite surfaces of the heat transfer structure(s). In some embodiments, the heat transfer assembly may include two heat transfer structures, each having opposite surfaces and at least one (e.g., one, two, three or more) recessed pathways (e.g., grooves, flutes, channels, etc.) in one of the opposite surfaces of the heat transfer structures.

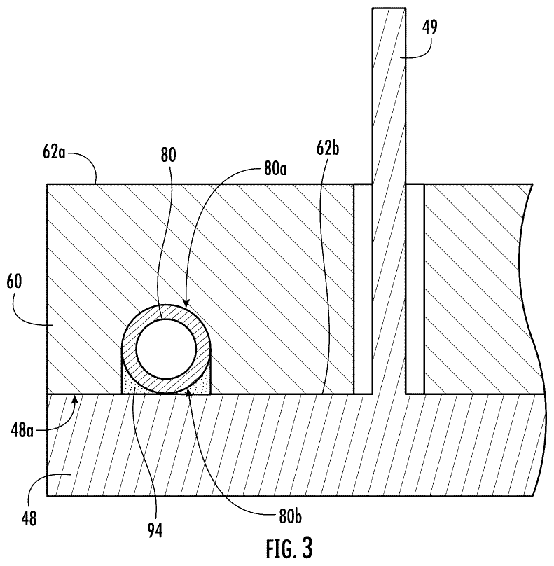

The heat transfer structure(s) of the heat transfer assembly 40 is made of a heat conductive material. Suitable heat conductive materials are known in the art and can include, without limitation, aluminum, stainless steel, and the like. As depicted for example in FIGS. 2 and 3, the heat transfer assembly 40 is positioned in the interior space 43 of the column oven 28 so that at least a portion of the one or more heat transfer structures are in a conductive heat transfer relationship with the heat source (e.g., with heat source 44 and/or 47 of FIG. 2).

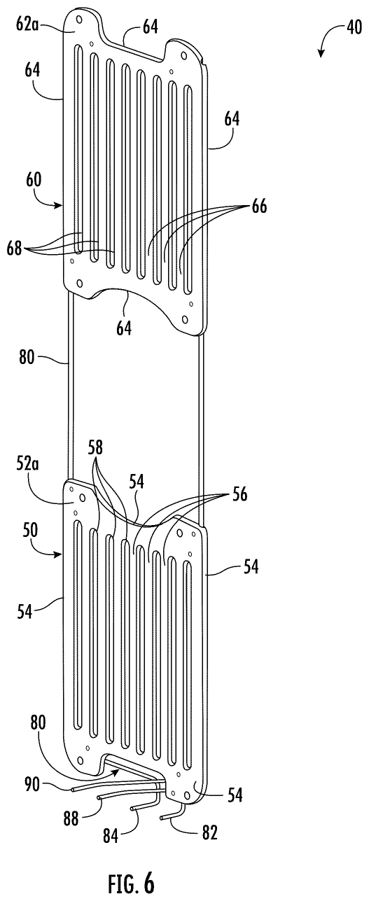

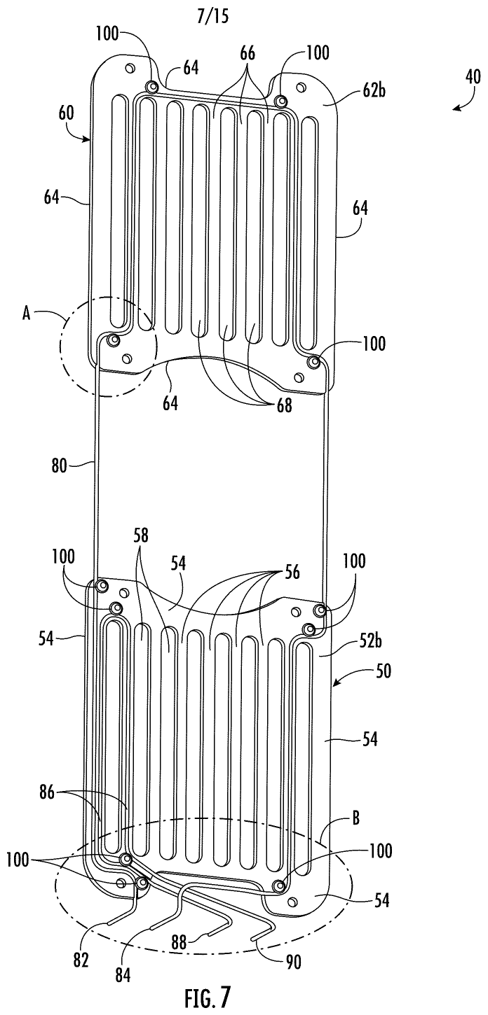

An exemplary embodiment of the heat transfer assembly 40 including two heat transfer structures is schematically depicted in more detail in, e.g., FIGS. 3 and 6-14. For example, referring to FIGS. 6 and 7, FIG. 6 is a front isolated view of the heat transfer assembly 40, and FIG. 7 is an isolated view of the opposite side of the heat transfer assembly 40 of FIG. 6, in accordance with embodiments of this disclosure.

In some embodiments, such as schematically depicted in FIGS. 6 and 7, the heat transfer assembly 40 may include at least one heat transfer structure in the form of a heat transfer plate 50 having opposite surfaces 52a and 52b and including four marginal members 54 and a plurality of spanning members 56 connecting two parallel marginal members of the four marginal members. The plurality of spanning members 56 defines a plurality of holes 58, more specifically, a plurality of through-holes in the form of slots.

The plurality of through-holes 58 of the heat transfer plate 50 can be configured so that a corresponding plurality of the fins 46 of the heat source 44 can go through the through-holes and provide face-to-face contact of the heat source(s) (e.g., face-to-face contact with the surface 45a of the heat plate 45) and the heat transfer assembly (e.g., with at least a portion of surface 52b of heat transfer plate 50, and also with exposed portions 80b of an exterior surface of a tubing 80 of the heat transfer assembly and exposed portions 86b of an exterior surface of a tubing 86 as further described herein).

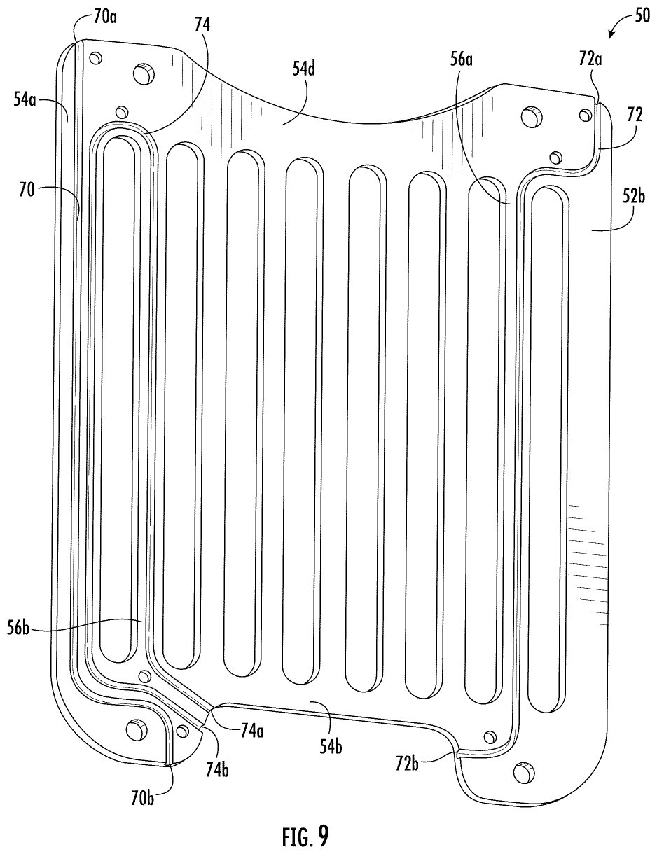

In some embodiments, at least a portion of the surface of one or more of the marginal members 54 and/or one or more of the spanning members 56 may be configured to define the one or more recessed pathways. For example, FIG. 9 is an isolated view of the heat transfer structure 50 of the heat transfer assembly 40 of FIG. 7 and schematically depicts a recessed pathway 70 along surface 52b and spanning, from an end 70a to an opposite end 70b of the recessed pathway 70, at least a portion of a marginal member 54d, a marginal member 54a, and a marginal member 54b; a recessed pathway 72 along surface 52b and spanning, from an end 72a to an opposite end 72b of the recessed pathway 72, at least a portion of the marginal member 54d, a spanning member 56a, and the marginal member 54b; and a recessed pathway 74 along surface 52b and spanning, from an end 74a to an opposite end 74b of the recessed pathway 74, at least a portion of marginal member 54b, spanning member 56b, marginal member 54d, marginal member 54a and marginal member 54b (to form, e.g., a loop).

In some embodiments, such as schematically depicted in FIGS. 6 and 7, the heat transfer assembly 40 may include at least another heat transfer structure in the form of a heat transfer plate 60 having opposite surfaces 62a and 62b and including four marginal members 64 and a plurality of spanning members 66 connecting two parallel marginal members of the four marginal members. The plurality of spanning members 66 defines a plurality of holes 68, more specifically, a plurality of through-holes in the form of slots.

The plurality of through-holes 68 of the heat transfer plate 60 can be configured so that a corresponding plurality of the fins 49 of the heat source 47 can go through the through-holes and provide face-to-face contact of the heat source(s) (e.g., face-to-face contact with the surface 48a of the heat plate 48) and the heat transfer assembly (e.g., with at least a portion of surface 62b of heat transfer plate 60 and also with portions 80b of the exterior surface of the tubing 80 of the heat transfer assembly, as further described herein).

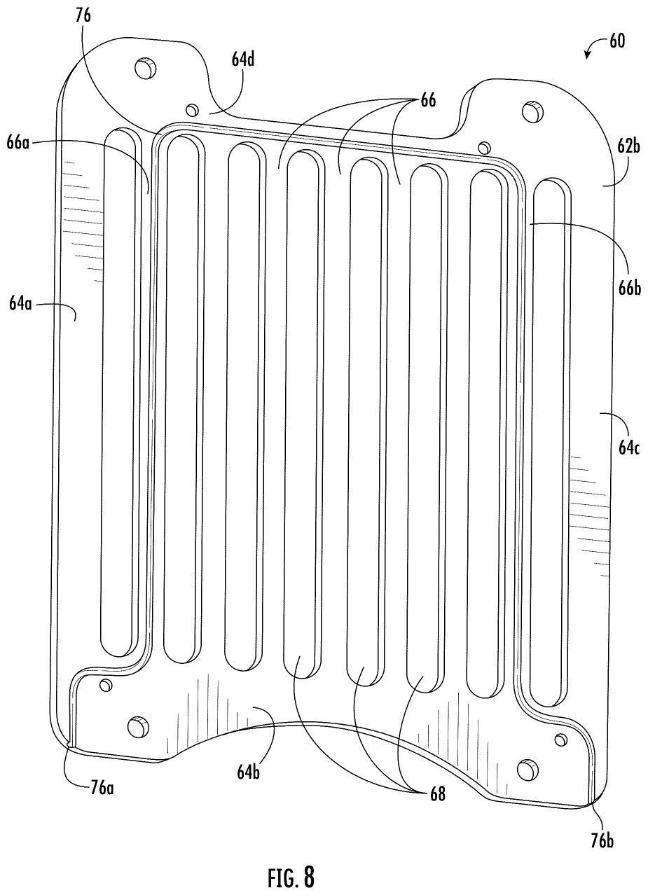

In some embodiments, at least a portion of the surface of one or more of the marginal members 64 and/or one or more of the spanning members 66 may be configured to define the one or more recessed pathways. For example, FIG. 8 is an isolated view of the heat transfer structure 60 of the heat transfer assembly 40 of FIG. 7 and schematically depicts at least one recessed pathway 76 along surface 62b and spanning, from an end 76a to an opposite end 76b of the recessed pathway 76, at least a portion of a marginal member 64b, a spanning member 66a, a marginal member 64d, a spanning member 66b, and the marginal member 64b (to roughly form, e.g., a square shaped loop).

As shown in FIGS. 8 and 9, the recessed pathways 70, 72, 74 and/or 76 may in some embodiments define one or more pathways generally parallel with one or more marginal members and/or generally parallel with one or more spanning members, and may include one or more curved portions (e.g., can generally form a loop such as depicted by recessed pathway 74; and/or can include an curved portion transitioning the recessed pathway from one marginal and/or spanning member to a different marginal and/or spanning member, such as depicted by recessed pathways 70, 72, 74 and/or 76).

Also as shown in the Figures (e.g., FIGS. 7, 8, and 9), plates 50 and 60 may be positioned relative to one another in the heat transfer assembly 40 to align one or more ends of one or more of the recessed pathways of plate 50 or 60 with one or more ends of one or more of the recessed pathways of the other of the plates 50 and 60. As a non-limiting example, the Figures schematically depict an exemplary heat transfer assembly 40 in which the end 76a of the recessed pathway 76 located along surface 62b of the marginal member 64b is aligned with the end 70a of the recessed pathway 70 located along surface 52b of marginal member 54d; and the opposite end 76b of recessed pathway 76 located along surface 62b of marginal member 64b is aligned with the end 72a of recessed pathway 72 located along surface 52b of marginal member 54d.

For ease of reference, heat transfer structure 50 may also be referred to herein as lower heat transfer structure 50 and heat transfer structure 60 may also be referred to herein as upper heat transfer structure 60.

Referring again to FIGS. 6 and 7, the heat transfer assembly 40 of the present disclosure also includes at least one tubing (e.g., a first tubing) defining a fluid flow path (e.g., a first mobile phase flow path) connecting a tubing inlet and a tubing outlet. The tubing inlet is configured to be capable of fluid communication with a mobile phase source (e.g., solvent manager 16 of FIG. 1) and the tubing outlet is configured to be capable of fluid communication with an inlet of a chromatography column (e.g., column 26 of FIG. 1).

As noted herein, the one or more heat transfer structure(s) of the heat transfer assembly 40 is made of a heat conductive material as known in the art, non-limiting examples of which may include aluminum, stainless steel, and the like, and the heat transfer assembly 40 is positioned in the interior space 43 of the column oven 28 so that at least a portion of the one or more heat transfer structures is in a conductive heat transfer relationship with the heat source. The at least one tubing is also formed of a heat conductive material, such as stainless steel.

The tubing is configured relative to the heat transfer structure so that at least a portion (e.g., a first portion) of an exterior surface of the tubing is in a conductive heat transfer relationship with at least one recessed pathway of at least one heat transfer structure of the heat transfer assembly (e.g., at least a first portion of the exterior surface of the tubing is in opposing surface-to-surface contact with a surface of the at least one recessed pathway of the at least one heat transfer structure of the heat transfer assembly). In addition, the tubing is configured relative to the heat transfer structure so that at least another portion (e.g., a second portion) of the exterior surface of the tubing is in a conductive heat transfer relationship with the heat source (e.g., at least a second portion of the exterior surface of the tubing is in opposing surface-to-surface contact with a surface of the heat source). With this structure, when a liquid (e.g., a mobile phase) flows through the tubing, the heat source can provide heat to the heat transfer structure for transfer (e.g., conductive heat transfer) to the first portion of the exterior surface of the tubing and to a mobile phase flowing through the tubing; the heat source can also provide heat to the second portion of the exterior surface of the tubing for transfer (e.g., conductive heat transfer) to the mobile phase flowing through the tubing. Accordingly, the tubing is configured with a surface area (e.g., a combined configuration of the inner and outer surface area of the tubing) sufficient to appropriately heat the liquid flowing through the tubing at a determined flow rate range. For example, the tubing may be configured with a surface area (e.g., a combined configuration of the inner and outer surface area of the tubing) sufficient to conductively transfer heat originating from the heat source through the tubing surface to pre-heat (e.g., to a temperature ranging from about 25° C. to about 80° C.) a mobile phase flowing through the tubing at a selected flow rate (e.g., a mobile phase flow rate ranging from about 4 mL/min. to about 40 mL/min.).

In some embodiments, the heat transfer assembly 40 can include at least another tubing (e.g., a second tubing) defining another (e.g., a second) fluid flow path (e.g., a second mobile phase flow path that is different from the first mobile phase flow path of the first tubing) connecting a tubing inlet (e.g., second tubing inlet) and a tubing outlet (e.g., a second tubing outlet) of the second tubing. The second tubing inlet is also configured to be capable of fluid communication with a mobile phase source (e.g., solvent manager 16 of FIG. 1) and the second tubing outlet is also configured to be capable of fluid communication with an inlet of a chromatography column (e.g., column 26 of FIG. 1).

The second tubing is also formed of a heat conductive material, such as stainless steel. The second tubing is configured relative to the heat transfer structure so that at least a portion (e.g., a first portion) of an exterior surface of the second tubing is in a conductive heat transfer relationship with at least another (e.g., a second) recessed pathway of the at least one heat transfer structure of the heat transfer assembly (e.g., at least a first portion of the exterior surface of the second tubing is in opposing surface-to-surface contact with a surface of a second recessed pathway of the at least one heat transfer structure of the heat transfer assembly). In addition, the second tubing is configured relative to the heat transfer structure so that at least another portion (e.g., a second portion) of the exterior surface of the second tubing is in a conductive heat transfer relationship with the heat source (e.g., at least a second portion of the exterior surface of the second tubing is in opposing surface-to-surface contact with a surface of the heat source). Further with this structure, when a liquid (e.g., a mobile phase) flows through the second tubing, the heat source can provide heat to the heat transfer structure for transfer (e.g., conductive heat transfer) to the first portion of the exterior surface of the second tubing and to a mobile phase flowing through the second tubing; the heat source can also provide heat to the second portion of the exterior surface of the second tubing for transfer (e.g., conductive heat transfer) to the mobile phase flowing through the second tubing. The second tubing is also configured with a surface area (e.g., a combined configuration of the inner and outer surface area of the second tubing) sufficient to appropriately heat the liquid flowing through the second tubing at a determined flow rate range. For example, the second tubing may be configured with a surface area (e.g., a combined configuration of the inner and outer surface area of the second tubing) sufficient to conductively transfer heat originating from the heat source through the tubing surface to pre-heat (e.g., to a temperature ranging from about 25° C. to about 80° C.) a mobile phase flowing through the tubing at a selected flow rate (e.g., a mobile phase flow rate ranging from about 4 mL/min. to about 40 mL/min.).

More specifically, in some embodiments, such as schematically depicted in FIGS. 6 and 7, the heat transfer assembly 40 includes at least one (e.g., a first) tubing 80 defining a first fluid flow path (e.g., a first mobile phase flow path) connecting a first tubing inlet 82 and a first tubing outlet 84. The first tubing inlet 82 is configured to be capable of being fluidly connected to (in fluid communication) with a mobile phase source (e.g., solvent manager 16 of FIG. 1) and the first tubing outlet 84 is configured to be capable of being fluidly connected to (in fluid communication with) an inlet of a chromatography column (e.g., column 26 of FIG. 1).

The first tubing 80 is further configured so that the first tubing 80 can be inserted into one or more of the recessed pathways of the one or more heat transfer structures to provide at least one or more portions of a flow path for a fluid (e.g., a mobile phase) flowing through the tubing 80 that is substantially the same as the pathway(s) of the recessed pathway(s) into which the tubing 80 is inserted. For example, as schematically depicted in FIG. 7 (and with reference to FIGS. 8, 9, 10, and 11), the tubing 80 can be shaped and/or sized (e.g., can have a shape, length, inner diameter, total interior volume, etc.) so that the tubing 80 fits into, and forms a continuous fluid pathway spanning (connecting) inlet 82 to outlet 84 through, the recessed pathway 70 of heat transfer structure 50, the recessed pathway 76 of heat transfer structure 60, and the recessed pathway 72 of heat transfer structure 50.

In addition, in some embodiments, such as schematically depicted in FIGS. 6 and 7, the heat transfer assembly 40 may include at least another (e.g., a second) tubing 86 defining a second fluid flow path (e.g., a second mobile phase flow path) connecting a second tubing inlet 88 and a second tubing outlet 90. The second tubing inlet 88 is also configured to be capable of being fluidly connected to (in fluid communication) with a mobile phase source (e.g., solvent manager 16 of FIG. 1) and the second tubing outlet 90 is also configured to be capable of being fluidly connected to (in fluid communication with) an inlet of a chromatography column (e.g., column 26 of FIG. 1).

The second tubing 86 is further configured so that the second tubing 86 can be inserted into at least another of the recessed pathways of the one or more heat transfer structures to provide at least a portion of a second flow path for a fluid (e.g., a mobile phase) flowing through the tubing 86 that is substantially the same as the pathway(s) of the recessed pathway(s) into which the tubing 86 is inserted. For example, as schematically depicted in FIG. 7 (and with reference to FIGS. 8, 9, 10, and 11), the tubing 86 can be shaped and/or sized (e.g., can have a shape, length, inner diameter, total interior volume, etc.) so that the tubing 86 fits into, and forms a continuous fluid pathway spanning (connecting) inlet 88 to outlet 90 through, the recessed pathway 74 of the heat transfer structure 50.

As noted herein, the tubing of the heat transfer assembly 40 (e.g., tubing 80 and 86) is configured with a surface area (e.g., a combined configuration of the inner and outer surface area of the tubing) sufficient to appropriately heat a liquid flowing through the tubing at a determined flow rate range. For example, a tubing may be configured with a surface area (e.g., a combined configuration of an inner surface area and an outer surface area of the tubing) sufficient to conductively transfer heat through the tubing surface to pre-heat (e.g., to a temperature ranging from about 25° C. to about 80° C.) a mobile phase flowing through the tubing at a mobile phase flow rate suitable for semi-preparative and/or preparative liquid chromatography methods (e.g., a mobile phase flow rate ranging from about 4 mL/minute to about 40 mL/minute). Tubing length, inner diameter, internal volume of the tubing, etc. may be selected based on a target mobile phase flow rate and/or target mobile phase temperature. Stated differently, the tubing dimensions (e.g., tubing length) can be tunable (e.g., customized, optimized, etc.) according to the desired flow rate range and/or mobile phase temperature of a given application. In some embodiments, at least one tubing (e.g., tubing 80) may be configured with a surface area sufficient to appropriately heat a liquid flowing through the tubing at a mobile phase flow rate ranging from about 15 mL/minute to about 40 mL/minute, and at least another tubing (e.g., tubing 86) may be configured with a surface area sufficient to appropriately heat a liquid flowing through the tubing at a mobile phase flow rate ranging from about 4 mL/minute to about 14 mL/minute. In addition, in some embodiments, tubing length and/or inner diameter can be selected to optimize a target mobile phase (eluent) sub-cooling temperature (e.g., to provide a lower eluent temperature than a temperature of a wall of a liquid chromatography column located in the interior of the column oven, such as the column 26 located in the interior of the column oven 28 as schematically depicted in FIG. 4).

As non-limiting examples, in some embodiments, the tubing length can range from about 10 inches to about 50 inches (e.g., from about 10 inches to about 20 inches for a mobile phase flow rate ranging from about 4 mL/min. to about 14 mL/min. and about 35 inches to about 45 inches for a mobile phase flow rate of about 15 mL/min. to about 40 mL/min.). In addition, in some embodiments, the tubing inner diameter can range from about 0.02 to about 0.04 inches, for example can be about 0.03 inches, and as another example can be about 0.04 inches; and in some embodiments, the internal volume of the tubing can range from about 0.1 to about 0.6 milliliters (mL), for example can be about 0.5 mL.

The present disclosure is not limited to the specific embodiments depicted in the figures. In some embodiments, the heat transfer structure(s) of the heat transfer assembly may, for example, include one, two, or more recessed pathways and/or associated tubing structures that may be the same or different from the recessed pathways and/or associated tubing structures (e.g., locations, shapes, dimensions such as length, inner diameter, total interior volume, etc. of the recessed pathway and/or tubing) depicted in the figures of the present application. As another example, in some embodiments, the heat transfer assembly may include one, two, or more heat transfer structures that may be the same or different from the heat transfer structures (e.g., the heat transfer plates) depicted in the figures of the present application, and, in some embodiments, the dimensions, shapes, numbers, etc. of associated structural elements (e.g., spanning members and/or through holes) may be the same or different from those depicted in the figures of the present application. These and other properties/structures of the heat transfer structures and associated recessed pathways and tubing structures accordingly may be vary and may be selected based on factors such as discussed herein.

FIGS. 6 and 7 also depict an embodiment of the present disclosure wherein at least one tubing (e.g., tubing 80) can also connect heat transfer plates 50 and 60 to form a unitary heat transfer assembly 40.

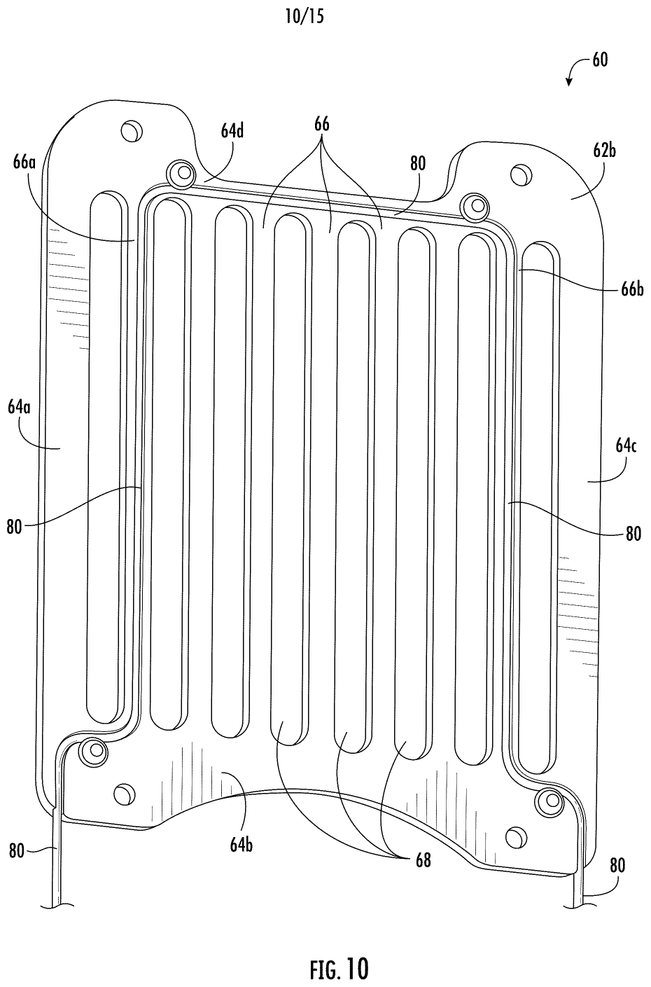

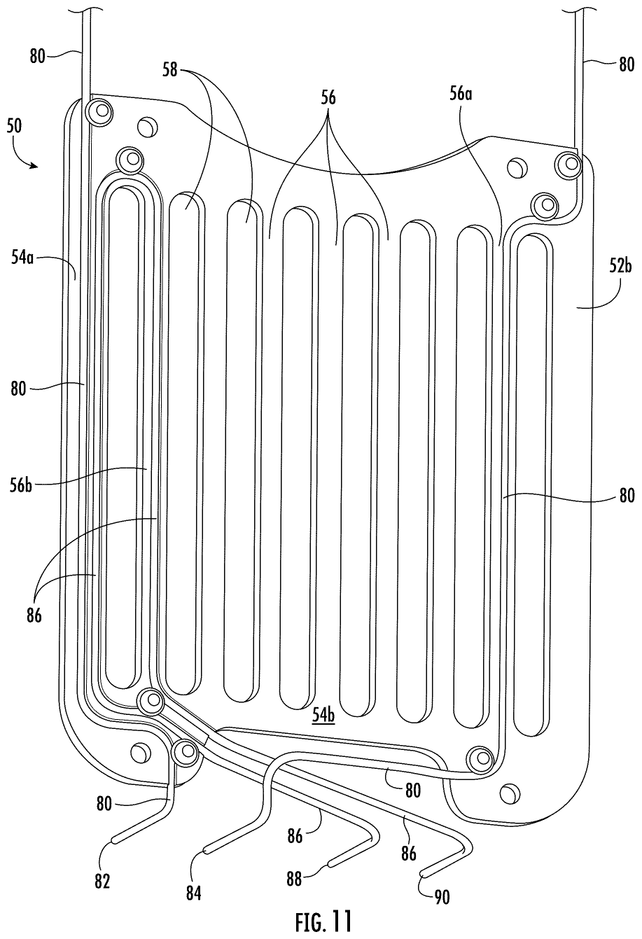

FIG. 10, which is an isolated view of the heat transfer plate 60 of FIG. 8 further depicts a section of tubing 80 located in the recessed pathway 76. Similarly, FIG. 11, which is an isolated view of the heat transfer plate 50 of FIG. 9, further depicts sections of tubing 80 located in recessed pathways 70 and 72 and the tubing 86 located in recessed pathway 74.

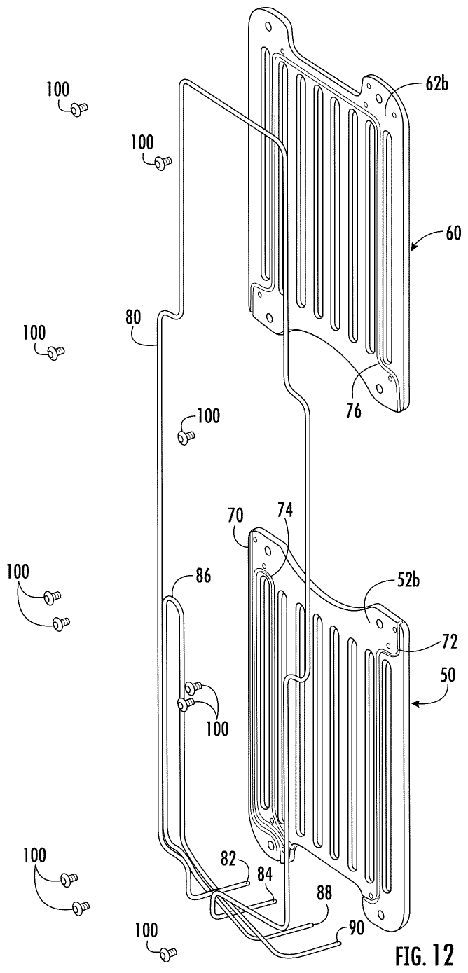

FIG. 12, which is an isolated exploded view of the heat transfer assembly of FIG. 7, further schematically depicts the corresponding structures (e.g., shapes, dimensions, etc.) of tubing 80 and recessed pathways 72, 76, and 74 and of tubing 86 and corresponding recessed pathway 74. FIG. 12 also schematically depicts a plurality of mechanical fasteners 100 (such as but not limited to screws) and associated holes that can be used to attach the tubing 80 and the tubing 86 to the heat transfer plates 50 and 60 in accordance with embodiments of this disclosure. See also, e.g., mechanical fasteners 100 depicted in the assembled heat transfer assembly 40 of FIGS. 7, 13, and 14.

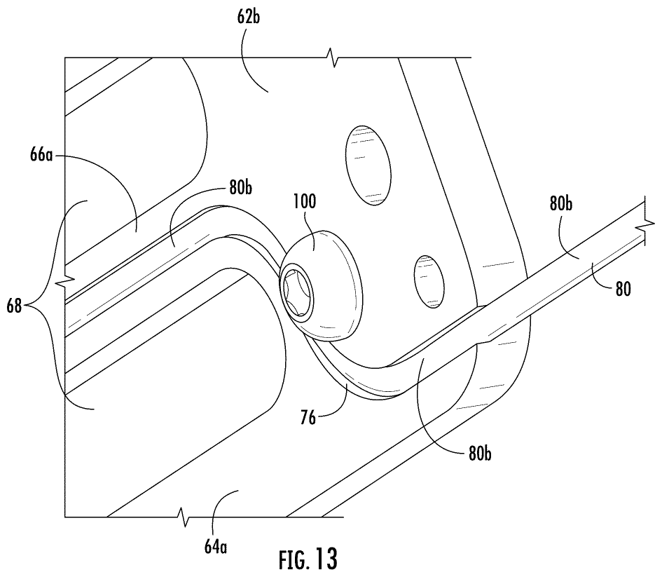

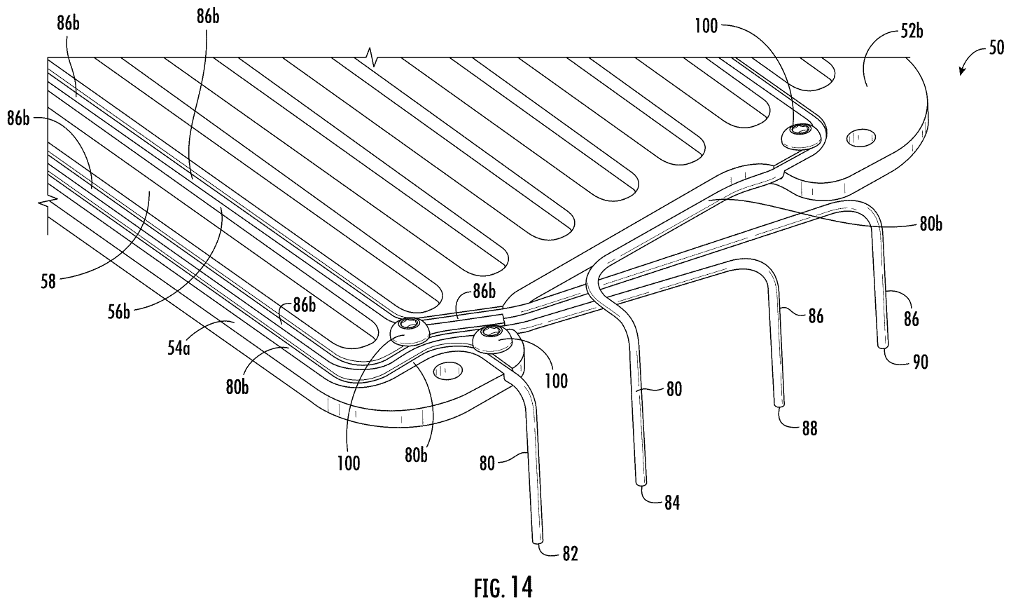

The tubing(s) is further configured so that when the tubing inserted into its corresponding recessed pathway(s), at least a portion of an exterior surface of the tubing is in a conductive heat transfer relationship with the recessed pathway(s) (e.g., at least a portion of an exterior surface of the tubing is in opposing surface-to-surface contact with a surface of the recessed pathway(s)). For example, a section (length, portion, etc.) of tubing 80 may be inserted into recessed pathway 76 of surface 62b of heat transfer plate 60 so that a corresponding section (length, portion, etc.) of an exterior surface of the tubing 80 is in a conductive heat transfer relationship with (e.g., in opposing surface-to-surface contact with a surface of) the recessed pathway 76 of the heat transfer plate 60. See, e.g., FIG. 3 (discussed in more detail herein), which schematically depicts a portion 80a of the exterior surface of tubing 80 in a heat conductive relationship with (e.g., in opposing surface-to-surface contact with a surface of) recessed pathway 76 of heat transfer plate 60. See also, e.g., FIG. 13, which is an isolated view of a portion of the heat transfer assembly of FIG. 7 indicated by circle “A” of FIG. 7. Other sections (e.g., lengths, portions, etc.) of tubing 80 may be inserted into recessed pathways 70 and 72 of surface 52b of heat transfer plate 50 so that corresponding sections (e.g., lengths, portions, etc.) of the exterior surface of the tubing 80 are also in a conductive heat transfer relationship with (e.g., in opposing surface-to-surface contact with a surface of) the respective recessed pathway 70 or 72 of the heat transfer plate 50. See, e.g., FIG. 14, which is another isolated view of a portion of the heat transfer assembly of FIG. 7 indicated by circle “B” of FIG. 7.

Similarly, a section (e.g., length, portion, etc.) of tubing 86 may be inserted into recessed pathway 74 of surface 52b of heat transfer plate 50 so that a corresponding length (e.g., section, portion, etc.) of an exterior surface of the tubing 86 is in a conductive heat transfer relationship with (e.g., in opposing surface-to-surface contact with a surface of) the recessed pathway 74 of the heat transfer plate 50. See again, e.g., FIG. 14, which is an isolated view of a portion of the heat transfer assembly of FIG. 7 indicated by circle “B” of FIG. 7.

In addition, the tubing(s) is further configured so that when the tubing inserted into its corresponding recessed pathway(s), an exposed portion of the exterior surface of the tubing (e.g., a portion of the exterior surface of the tubing that does not contact a surface of the recessed pathway) is substantially flush with the surface of the heat transfer structure in which the recessed pathway is located. For example, a section (length, portion, etc.) of tubing 80 may be inserted into recessed pathway 76 of surface 62b of heat transfer plate 60 so that a portion 80b of the exterior surface of the tubing 80 (e.g., a portion 80b of the exterior surface of the tubing 80 not contacting a surface of the recessed pathway 76) is substantially flush with the surface 62b of the heat transfer plate 60. Again see, e.g., FIG. 3 and FIG. 13. Other sections (lengths, portions, etc.) of tubing 80 may be inserted into recessed pathways 70 and 72 of surface 52b of heat transfer plate 50 so that the corresponding portions 80b of the exterior surface of the tubing 80 (e.g., the portions 80b of the exterior surface of the tubing 80 not contacting a surface of the recessed pathway 70 or 72) are substantially flush with the surface 52b of the heat transfer plate 50. Again see, e.g., FIG. 14.

Similarly, a section (e.g., length., portion, etc.) of tubing 86 may be inserted into recessed pathway 74 of surface 52b of heat transfer plate 50 so that a portion 86b of the exterior surface of the tubing 86 (e.g., a portion 86b of the exterior surface of the tubing 86 not contacting a surface of the recessed pathway 74) is substantially flush with the surface 52b of the heat transfer plate 50. See again, e.g., FIG. 14.

The structural and functional relationship of the tubing(s) and the respective recessed pathway(s) of the heat transfer plate(s) in which the tubing(s) is inserted, as well as the positioning of the heat transfer plates(s) relative to the heat source(s) as described and depicted herein, can facilitate heating (e.g., pre-heating) the mobile phase flowing through the tubing(s). More specifically, as schematically depicted in FIG. 2 (and also FIG. 3), the heat transfer assembly 40 is positioned (oriented) so that surfaces 52b and 62b of the heat transfer plates 50 and 60, respectively, and also so that portions 80b and 86b of the exterior surfaces of tubing 80 and tubing 86, respectively, are in a conductive heat transfer relationship with (e.g., in opposing surface-to-surface contact with a surface of) the heat source 44 and/or the heat source 47, respectively. For example, the surface 52b of the heat transfer plate 50 may be in a face-to-face relationship (e.g., in opposing surface-to-surface contact) with the surface 45a of the heat plate 45; similarly, portion(s) 80b and/or 86b of the exterior surfaces of the tubing 80 and the tubing 86, respectively, may be in a face-to-face relationship (e.g., in opposing surface-to-surface contact) with the surface 45a of the heat plate 45. As another example, the surface 62b of the heat transfer plate 60 may be in a face-to-face relationship (e.g., in opposing surface-to-surface contact) with the surface 48a of the heat plate 48; similarly, portion(s) 80b of the exterior surface of the tubing 80 may be in a face-to-face relationship (e.g., in opposing surface-to-surface contact) with the surface 48a of the heat plate 48.

In some embodiments (e.g., for conducting semi-preparative and/or preparative chromatography at a relatively high mobile phase flow rate as defined herein), the heat source 47 (e.g., heat plate 48) can provide heat (e.g., conductively transfer heat) to the heat transfer plate 60 for transfer of the heat (e.g., conductive transfer of the heat) to the section 80a of the exterior surface of the tubing 80 that is in the conductive heat transfer relationship (e.g., in opposing surface-to-surface contact) with the recessed pathway 76 of the heat transfer structure 60; and the heat can further transfer (e.g., conductively transfer) from the section 80a of the exterior surface of the tubing 80 to a mobile phase flowing through the tubing 80. In addition, the heat source 47 (e.g., heat plate 48) can provide heat (e.g., conductively transfer heat) to the section 80b of the exterior surface of the tubing 80 that is in the conductive heat transfer relationship (e.g., in opposing surface-to-surface contact) with the heat plate 48 and to the mobile phase flowing through the tubing 80.

In a similar manner, further in some embodiments (e.g., for conducting semi-preparative and/or preparative chromatography at a relatively high mobile phase flow rate as defined herein), the heat source 44 (e.g., heat plate 45) can provide heat (e.g., conductively transfer heat) to the heat transfer plate 50 for transfer (e.g., conductive heat transfer) of the heat to the section of the exterior surface of the tubing 80 that is in a conductive heat transfer relationship (e.g., in opposing surface-to-surface contact) with the recessed pathways 70 and 72 of the heat transfer structure 50; and the heat can further transfer (e.g., conductively transfer) from the section of the exterior surface of the tubing 80 that is in a conductive heat transfer relationship (e.g., in opposing surface-to-surface contact) with the recessed pathways 70 and 72 of the heat transfer structure 50 to a mobile phase flowing through the tubing 80. In addition, the heat source 44 (e.g., heat plate 45) can provide heat (e.g., conductively transfer heat) to the section 80b of the exterior surface of the tubing 80 that is in the conductive heat transfer relationship (e.g., in opposing surface-to-surface contact) with the surface 45a of the heat plate 45 and to the mobile phase flowing through the tubing 80.

In some other embodiments (e.g., for conducting semi-preparative and/or preparative chromatography at a relatively low mobile phase flow rate as defined herein), the heat source 44 (e.g., heat plate 45) can provide heat (e.g., conductively transfer heat) to the heat transfer plate 50 for transfer (e.g., conductive heat transfer) of the heat to the section of the exterior surface of the tubing 86 that is in the conductive heat transfer relationship (e.g., in opposing surface-to-surface contact) with the recessed pathway 74 of the heat transfer structure 50; and the heat can further transfer (e.g., conductively transfer) from the section of the exterior surface of the tubing 86 that is in a conductive heat transfer relationship (e.g., in opposing surface-to-surface contact) with the recessed pathway 74 of the heat transfer structure 50 to a mobile phase flowing through the tubing 86. In addition, the heat source 44 (e.g., heat plate 45) can provide heat (e.g., conductively transfer heat) to the section 86b of the exterior surface of the tubing 86 that is in the conductive heat transfer relationship (e.g., in opposing surface-to-surface contact) with the surface 45a of the heat plate 45 and to the mobile phase flowing through the tubing 86.

In some embodiments (e.g., for conducting semi-preparative and/or preparative chromatography at a relatively high mobile phase flow rate as defined herein), at least a portion of the exterior surface of the tubing may be in direct thermal contact with the heat source. As a specific example, in some embodiments, a section 80b of the exterior surface of the tubing 80 may be in a direct surface-to-surface conductive heat transfer relationship (e.g., in opposing surface-to-surface contact) with a portion of the surface 45a of the heat plate 45 and/or a portion of the surface 48a of the heat plate 48. Similarly, in some embodiments (e.g., for conducting semi-preparative and/or preparative chromatography at a relatively low mobile phase flow rate as defined herein), a section 86b of the exterior surface of the tubing 86 may be in a direct surface-to-surface conductive heat transfer relationship (e.g., in opposing surface-to-surface contact) with a portion of the surface 45a of the heat plate 45.

In some other embodiments, a thermal interface material (TIM) such as thermal grease may be interposed between at least a portion of the exterior surface of the tubing and a surface of the associated recessed pathway of the heat transfer structure and/or between at least a portion of the exterior surface of the tubing and a surface of the heat source. See, e.g., FIG. 3, which again is a portion of a cross-sectional view taken along line 3-3 of FIG. 2. FIG. 3 schematically depicts an exemplary embodiment (e.g., when conducting chromatography at a relatively high mobile phase flow rate as defined herein), wherein tubing 80 is positioned in recessed pathway 76 of heat transfer plate 60, a TIM 94 is interposed between at least a portion 80a and/or 80b of the exterior surface of the tubing 80 and a surface of the recessed pathway 76 and/or the surface 48a of the heat plate 48. In the embodiment depicted in FIG. 3, the TIM 94 can be applied to a surface of the heat source (e.g., a surface 48a of the heat plate 48 of heat source 47) and/or to a surface of the heat transfer assembly 40 (e.g., to a surface 62b of heat transfer plate 60 and/or to the exterior surface of the tubing 80 in the recessed pathway 76, e.g., to the section 80b of the exterior surface of the tubing 80 in the recessed pathway 76). The heat transfer assembly 40 can then be attached to the heat source under conditions (e.g., pressure) sufficient to substantially fill in gaps, irregularities, etc., between the surface 48a of the heat plate 48, the exterior surface of the tubing 80, and/or the surface of the recessed pathway 76, with the TIM 94.

In a similar manner, further in some embodiments (e.g., when conducting chromatography at a relatively high mobile phase flow rate as defined herein), the thermal interface material may be interposed between at least a portion of the exterior surface of the tubing 80 and a surface of the recessed pathway 70 and/or 72 of the heat transfer plate 50 and/or the surface 45a of the heat plate 45. The TIM can, for example, be applied to a surface 45a of the heat plate 45 and/or to a surface of the heat transfer assembly 40 (e.g., to a surface 52b of heat transfer plate 50 and/or to the section 80b of the exterior surface of the tubing 80 in recessed pathways 70 and 72), and the heat transfer assembly 40 can be attached to the heat source under conditions (e.g., pressure) sufficient to substantially fill in gaps, irregularities, etc., between the surface 45a of the heat plate 45, the exterior surface of the tubing 80 and/or the surfaces of recessed pathways 70 and 72.

As another example, in some embodiments (e.g., when conducting chromatography at a relatively low mobile phase flow rate as defined herein), the thermal interface material may be interposed between at least a portion of the exterior surface of the tubing 86 and a surface of the recessed pathway 74 of the heat transfer plate 50 and/or the surface 45a of the heat plate 45. The TIM can, for example, be applied to a surface 45a of the heat plate 45 and/or to a surface of the heat transfer assembly 40 (e.g., to a surface 52b of heat transfer plate 50 and/or to the section 86b of the exterior surface of the tubing 86 in recessed pathway 74), and the heat transfer assembly 40 can be attached to the heat source under conditions (e.g., pressure) sufficient to substantially fill in gaps, irregularities, etc., between the surface 45a of the heat plate 45, the exterior surface of the tubing 86, and/or the surface of recessed pathway 74.

Suitable thermal interface material (TIM) materials for use in accordance with the present disclosure may include without limitation thermal greases, thermal pastes, thermal gels, thermal compounds, etc. TIMs can include thermally conductive fillers, such as aluminum oxide, zinc oxide, boron nitride, and/or other thermally conductive materials, mixed with a binding agent such as a silicone or polymer compound. TIMs are known in the art and are commercially available.

As schematically depicted in FIG. 5, the column oven 28 also includes the column 26 configured for liquid column chromatography (e.g., configured for semi-preparative and/or preparative scale liquid chromatography). As noted herein, the drawings including FIG. 5 are schematic, and features depicted therein (e.g., column 26) may not be drawn to scale. In accordance with some embodiments of the present disclosure, a column inlet located at a portion (e.g., a lower portion) of the column 26 is fluidly connected to (in fluid communication with) an outlet of a tubing of the heat transfer assembly 40 (also depicted schematically by flow path 30 of FIG. 1), which will be described in more detail herein. FIG. 5 also schematically depicts a column outlet located in an opposite portion (e.g., an upper portion) of the column 26 in fluid communication with the detector 34 via a suitable fluid conduit such as indicated by the dashed lines 102, with an arrow 104 indicating the direction of the fluid flowing out of the column 26 (also depicted schematically by flow path 32 of FIG. 1).

As schematically depicted in FIGS. 2, 4, and 5, inlet 82 and outlet 84 of the tubing 80 may be connected to a tubing mounting bracket 91 by way of corresponding fittings (e.g., corresponding bulkhead fittings) 92a and 92b, respectively. Similarly, inlet 88 and outlet 90 of the tubing 86 may be connected to the tubing mounting bracket 91 by way of corresponding fittings (e.g., corresponding bulkhead fittings) 92c and 92d, respectively. It is noted that FIG. 5 depicts the mounting bracket as part of an interior panel or wall 91 and that FIGS. 2 and 4 depict only the lower portion of the interior panel for ease of reference to the various elements of the column oven.

Fittings 92a and 92c may each be configured to fluidly connect tubing inlet 82 or tubing inlet 88 with a mobile phase source (e.g., the solvent manager 16 of FIG. 1). Fittings 92b and 92d may each be configured to fluidly connect tubing outlet 84 or tubing outlet 90 with an inlet (not shown) of the column 26.

For example, FIG. 5 depicts an exemplary arrangement for pre-heating a flowing mobile phase prior to sample injection using relatively “lower” mobile phase flow rates (e.g., from about 4 to about 10 mL/min.). FIG. 5 depicts the fitting 92c fluidly connecting the tubing inlet 88 of the “relatively lower flow rate” tubing 86 via a suitable fluid conduit such as indicated by dashed lines 106 with an upstream mobile phase source (e.g., solvent source 18), with the direction of the mobile phase flow indicated by arrow 108 (see also flow path 22 of FIG. 1). FIG. 5 further depicts the fitting 92d fluidly connecting the tubing outlet 90 of the “relatively lower flow rate” tubing 86 via a suitable fluid conduit such as tubing 110 (see also flow path 30 of FIG. 1). In this manner, the solvent pump 20 may pump solvent from the solvent source 18 at a pressure selected to provide a suitable solvent flow through conduit 106 (flow path 22), inlet 88, tubing 86 (where the solvent is heated as discussed in more detail herein), outlet 90, tubing 110, column 26, flow path 32 and to detector 34.

The system of the present disclosure can be readily re-configured to provide pre-heating of a mobile phase prior to sample injection using relatively “higher” mobile phase flow rates (e.g., from about 15 to about 40 ml/min.). For example, the system can be re-configured so that fitting 92a fluidly connects the tubing inlet 82 of the “relatively higher flow rate” tubing 80 via a suitable fluid conduit with the upstream mobile phase source (e.g., solvent source 18; see also flow path 22 of FIG. 1). The system can be further re-configured so that the fitting 92b fluidly connects the tubing outlet 84 of the “relatively lower higher rate” tubing 80 via a suitable fluid conduit such as tubing 110 (see also flow path 30 of FIG. 1). In this manner, the solvent pump 20 may pump solvent from the solvent source 18 at a pressure selected to provide a suitable solvent flow through a conduit (flow path 22), inlet 82, tubing 80 (where the solvent is heated as discussed in more detail herein), outlet 84, tubing 110, column 26, flow path 32 and to detector 34.

Turning again to FIGS. 2 and 4, as schematically depicted therein, the column oven 28 can further include a fan 112 mounted within the interior space 43 of the column oven 28 (e.g., mounted on an inner surface of the rear wall 42b using a suitable mounting bracket 114 and/or mechanical fasteners such as screws). The fan 112 is configured to generate air flow and circulate radiant heat generated by the heat source(s) 44 and/or 47 (e.g., generated by the heat plates 45 and/or 48) within the interior of the column oven 28 (e.g., to convectively heat the interior of the column oven 28, a liquid chromatography column 26 (FIG. 5), a stationary phase located within the column 26, and/or a mobile phase flowing through the column 26). As heat moves conductively from the heat plates 45 and/or 48 to fins 46 and/or 49, respectively, the fins 46 and/or 49 may assist in (increase) convection heating of the interior of the column oven, for example, increasing the surface area in contact with the convection medium (e.g., air). As further schematically depicted in FIG. 5, the interior wall or panel 91 may include at least a portion thereof formed of a suitable screen material 116 to facilitate convective heating (e.g., the flow/circulation of heated air in the interior space 43 of the column oven 28 by the fan 112).

Also as schematically depicted in FIG. 5, the column oven 28 may include a temperature sensor 118 (e.g., a thermocouple mounted on the screen 116). The sensor 118 is configured to measure the temperature of the interior of the column oven 28 and to generate a signal indicative of the measured temperature of the interior of the column oven and electronically communicate the signal with the system controller or computer (e.g., processor) 12. With reference to FIG. 1, and as discussed in more detail herein, the controller or computer 12 is configured to control the temperature of the interior space of the column oven 28 by increasing or decreasing heat generated by the heat source 44 and/or heat source 47 (e.g., by increasing or decreasing an electric current directed to the heat source 44 and/or heat source 47) in response to an input (e.g., the signal from the sensor 118).

As noted herein, a benefit of the present disclosure is the ability to use the same heat source both to heat the mobile phase flowing through the system (e.g., to conductively pre-heat the mobile phase flowing through the tubing of the heat transfer assembly before sample injection); and also to indirectly (e.g., convectively) heat the interior of column oven (and the column, including a stationary phase within the column, before, during, and/or after sample injection), for example, using the fan 112 located in the column oven configured to circulate radiant heat provided by the heat source.

Another benefit of the present disclosure is the ability to use a single temperature sensor (e.g., a single thermocouple) to monitor the temperature of the column oven, in accordance with some embodiments and as discussed in more detail below.

The present disclosure also relates to methods of heating a flowing liquid in a liquid chromatography (LC) system (e.g., a high-performance liquid chromatography or HPLC system, or other types of chromatography systems involving the flow of a sample-bearing mobile phase through a column including packing or a bed supporting a stationary phase). More specifically, the present disclosure also relates to methods for heating a flowing liquid in a LC system in a liquid chromatography column oven of a LC system (e.g., for pre-heating a flowing mobile phase or eluent in a liquid chromatography column oven prior to sample injection/directing a sample carried by the mobile phase) at mobile phase flow rates ranging from about 4 mL/min. to about 40 mL/min. (e.g., at a semi-preparative and/or preparative scale wherein one or more sample components are collected after separation).

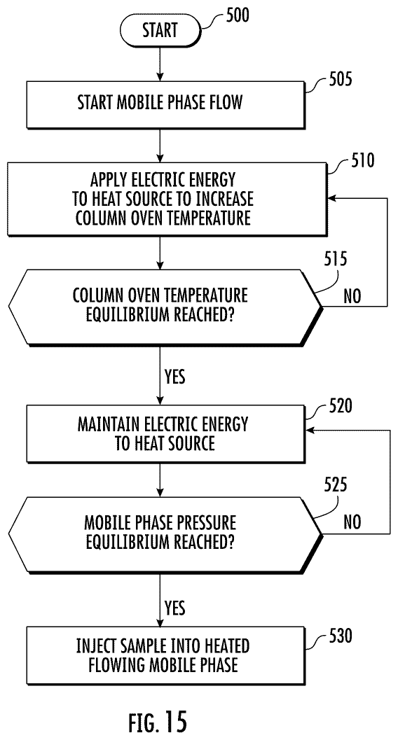

FIG. 15 depicts a flow diagram of an example of a method (schematically depicted by blocks 500-530 in FIG. 15) associated with, for example, pre-heating a flowing mobile phase flowing at a rate ranging from about 4 mL/min. to about 40 mL/min. in association with the system schematically depicted in FIG. 1 including a heat transfer assembly 40 depicted in FIGS. 2-14 prior to sample injection. Referring primarily to FIG. 15 and occasionally to FIGS. 1, 2, and 4-5, at block 500, a processor of the controller or computer 12 can provide signals to and receive signals from a graphical user interface 14 of the computer to facilitate a user selecting preprogrammed methods of operation or create custom methods of operation of the column oven 28 (e.g., operation of the heat sources 44 and/or 47). For example, at block 500, the processor can facilitate programming of at least the following parameters in response to user inputs: column oven set point temperature—sets the desired temperature in the column oven; column oven temperature delta—sets a temperature delta between a column oven temperature (e.g., a column oven measured temperature) and the column oven set point temperature (e.g., a column oven temperature within 1° C. of the column oven set point temperature); and column oven temperature delta duration-sets a duration of the column oven temperature delta (e.g., for 1 minute). The column oven temperature set point can range, for example, from about 25° C. to about 80° C. Parameters such as column oven set point temperature, column oven temperature delta, and column oven temperature delta duration can be designed to assess temperature equilibration (e.g., wherein a column oven temperature within 1° C. of the column oven set point temperature is maintained for 1 minute), and the skilled artisan will understand how to assess the same.

In addition, in some embodiments, mobile phase pressure parameter(s) may be used (e.g., a desired mobile phase pressure deviation over time) to assess pressure equilibrium, as discussed below and as known in the art. Pressure-related parameter(s) may be used instead of or in addition to column oven temperature-related parameters to supplement temperature equilibration status or to serve as a proxy for temperature equilibration status.

As discussed herein, FIG. 5 depicts a heat transfer assembly 40 set-up in which the inlet 88 of tubing 86 is in fluid communication with the solvent source 18/pump 20 via flow path 22 and the outlet 90 of the tubing 86 is in fluid communication with the column 26 via flow path 30. In this set-up, examples of possible user input parameters may include: the column oven temperature set point may be set to about 60° C.; the column oven temperature delta may be set to 1° C.; and the column oven temperature delta duration can be set to 1 minute (e.g., to assess temperature equilibration when a column oven temperature within 1° C. of the column oven set point temperature is maintained for 1 minute). In addition, in this set-up, a mobile phase target flow rate may be set at a range from about 4 mL/min. to about 15 mL/min., and/or a pre-defined solvent flow ramping rate may be selected, as discussed below. The present disclosure, however, is not limited to the specific assembly set up depicted in the Figures or to the specific user input parameters noted herein (e.g., a mobile phase flow rate at a range from about 15 mL/min. to about 40 mL/min.).

Processing control is transferred from block 500 to block 505. At block 505, the processor causes signal(s) to be sent in a manner that initiates the flow of a mobile phase through the liquid chromatography system 10 of FIG. 1. This may include, for example, sending signal(s) to the solvent pump 20 to pump a solvent(s) at the predetermined solvent flow rate and/or solvent pressure and/or solvent flow ramping rate from the solvent source 18 along the flow paths generally depicted in FIG. 1 and also as described herein with reference to FIGS. 2-14. For example, the pump 20 can pump solvent(s) from the solvent source 18 along flow path 22 into the column oven 28, through the inlet 88, tubing 86 (e.g., along the mobile phase flow path defined by the tubing 86), and outlet 90, along flow path 30 into the column 26, along flow path 32 to the detector, and to the diverter valve 36, which can be set to direct the flowing mobile phase to waste. In some embodiments, mobile phase flow rate stability may be monitored using conventional sensors, instruments, systems, methods, etc. as known in the art for monitoring mobile phase flow rate in a liquid chromatography column/system. For example, in some embodiments, a pump such as solvent pump 20 may have pre-defined parameters (e.g., mobile phase target flow rates, solvent flow ramping rates, etc.) that may be selected by an operator and initiated as known in the art to provide a substantially stable mobile phase flow rate within the liquid chromatography system (including within the heat transfer assembly 40 as described herein).

Processing control is transferred from block 505 to block 510. Blocks 510 and 515 can be generally representative of a do loop or for-loop that is executed or performed in association with conductively heating (e.g., pre-heating) the mobile phase flowing through tubing 80 or 86 and/or with convectively heating the interior space of the column oven 28.

At block 510, the processor causes signal(s) to be sent in manner that causes the heat source 44 and/or 47 in the column oven 28 to generate heat (e.g., before, after, or substantially simultaneously with the initiation of the mobile phase flow at block 505). For example, in response to the one or more signals at block 510, electric energy or power (e.g., an electric current and/or voltage) can be sent to heat sources 44 and/or 47 to generate thermal energy (e.g., conductive heat) to heat the mobile phase flowing through the tubing 86 of the heat transfer assembly 40 as described herein. Also at block 510, the processer can send a signal(s) to the fan 112 to initiate circulation of air heated by the heat sources 44 and/or 47 (e.g., by conductive and/or radiant heat) to convectively heat the interior 43 of the column oven.

At block 515, the processor receives signal(s) indicative of the temperature in the interior of the column oven 28. For example, the processor can receive signals from the temperature sensor 118 and can determine whether column oven temperature equilibrium (e.g., a column oven temperature within 1° C. of the column oven set point temperature for 1 minute) has been reached based upon the signals from the temperature sensor 118. In response to the sensor reading, at block 515, a determination is made whether to adjust the heat output of the heat source 44 and/or 47 based on the measured column oven temperature and the column oven set point temperature, and the processor can cause signal(s) to be sent to the heat source 44 and/or 47 to adjust the heat output by increasing or decreasing the electric energy or power (e.g., electric current or voltage) sent to the heat source 44 and/or 47. For example, electric current can continue to be applied to the heat source 44 and/or 47 to increase the temperature of the interior space 43 of the column oven 28 until the column oven temperature equilibrium (e.g., a column oven temperature within 1° C. of the column oven set point temperature for 1 minute) is reached. The processor can accordingly adjust the heat output of the heat source 44 and/or 47 based on the temperature of the column oven measured by the sensor 118 and on the column oven set point temperature (e.g., the processor can cause signal(s) to be sent to the heat source 44 and/or 47 to adjust the heat output by increasing or decreasing the electric current sent to the heat source 44 and/or 47).

In some embodiments, at least a second temperature sensor (e.g., a second thermocouple) may be mounted onto one or more of the tubing inlets and/or outlets (e.g., one or more of inlet 82 and/or outlet 84 of tubing 80 and/or one or more of inlet 88 and/or outlet 90 of tubing 86) as a way to monitor fluid temperature and potentially serve as a secondary control parameter.

Once the column oven temperature equilibrium is reached, processing control can be transferred from block 515 to block 520. Blocks 520 and 525 can be generally representative of a do loop or for-loop that is executed or performed in association with assessing mobile phase pressure equilibrium while maintaining electric power to the heat source to maintain column oven temperature equilibrium. For example, at block 520, the processor may send signals to the heat source 44 and/or 47 to maintain the electric current being applied to the heat sources 44 and/or 47.

In some embodiments, the mobile phase flow pressure may be monitored using conventional sensors, instruments, systems, methods, etc. as known in the art for monitoring mobile phase flow pressure in a liquid chromatography system. The mobile phase flow pressure may be monitored at the start of mobile phase flow initiation at block 505 and during pre-heating the mobile phase flow using the heat transfer assembly/method as described herein. Mobile phase pressure flow may also be monitored during liquid chromatography steps (e.g., following sample injection and during sample analysis, etc.), as also known in the art. For example, in some embodiments, a pump (e.g., the solvent pump 20) may include a conventional pressure sensor 21 configured to provide a signal indicative of the pressure of the mobile phase flow. The processor may receive the signal(s) from the pressure sensor 21 in the pump 20 and can determine a mobile phase pressure deviation based upon the signal(s) received from the pressure sensor. As will be understood by the skilled artisan, pressure deviation is typically assessed as a percentage of the current trending value. This assessment is typically known as pressure ripple. As a non-limiting example, if pressure deviates 5 bar over a period of 1 to 3 minutes (typically) for a pressure of 100 bar, the ripple would be 5%. In some embodiments, the pump may have a specification of better than 2% ripple, but this can range from less than 1% to more than 2% for other pumps. In this manner, mobile phase pressure equilibrium can be determined as known in the art using conventional sensors, instruments, systems, methods, etc. for monitoring mobile phase flow pressure in a liquid chromatography system.

Once the mobile phase pressure equilibrium is reached, at block 530, the processor may send signals to a suitable user interface to indicate that the mobile phase pressure equilibrium has been reached and that the sample may be injected into the flowing mobile phase.

Reiterating from above, due to convective heating principles, the temperature of the heat source 44 and/or 47 is necessarily higher than the column oven temperature set point (and/or higher than the measured temperature of the interior of the column oven), and the heat load (e.g., the mobile phase flow rate, the length of the tubing—e.g., tubing 80 or 86—of the heat transfer assembly 40, and column size of the column 26) in the column oven 28 may affect the magnitude of this temperature difference. In some embodiments, the temperature difference between the temperature of the heat source 44 and/or 47 and the column oven temperature set point (and/or than the measured temperature of the interior 43 of the column oven 28) can range from about 5° C. to about 25° C., for example from about 20° C. to about 25° C., and as another example can be about 20° C. Stated differently, the temperature of the heat source 44 and/or 47 can be maintained at a higher temperature (e.g., about 20° C. higher) than the column oven temperature set point. Thus, signals received from the temperature sensor are indicative of the measured temperature of the interior space 43 of the column oven 28, and by extrapolation, based, e.g., on the heat load as described herein, also an indication of the higher temperature of the heat source 44 and/or 47.

Further reiterating from above, without being bound by any explanation or theory of the invention, it is currently believed that the higher temperature of the heat source 44 and/or 47 as compared to the temperature of the interior 43 of the column oven 28 (and/or as compared to the column oven temperature set point), and also the conductive heating of the tubing by the heat source, can improve heat transfer to the flowing mobile phase and thus can advantageously be used to minimize required tubing length (and therefore tubing internal volume) in the heat transfer assembly 40 as a result of improved heat transfer. The ability to minimize the required tubing length may facilitate integration of the heat transfer assembly in the interior of the column oven, which can eliminate the need for a separate and dedicated mobile phase heater for semi-preparative and preparative applications. Integration of the heat transfer assembly in the interior of the column oven can reduce cost and complexity of the liquid chromatography system and facilitate the use of elevated temperature conditions (e.g., up to about 80° C.) for semi-preparative and preparative applications. Minimization of the tubing internal volume may also help reduce extra column band broadening.

Further reiterating from above, a benefit of the present disclosure is the ability to use the same heat source both for conductive heating a mobile phase flowing through the system (e.g., conductively pre-heating the mobile phase before sample injection); and indirect heating (e.g., convection heating) of the interior space 43 of the column oven 48, including convection heating a stationary phase of the column (e.g., before and after sample injection).

Reiterating from above, it is within the scope of this disclosure for one or more of the terms “substantially,” “about,” “approximately,” and/or the like, to qualify each of the adjectives and adverbs of the foregoing disclosure, for the purpose of providing a broad disclosure. As an example, it is believed that those of ordinary skill in the art will readily understand that, in different implementations of the features of this disclosure, reasonably different engineering tolerances, precision, and/or accuracy may be applicable and suitable for obtaining the desired result. Accordingly, it is believed that those of ordinary skill will readily understand usage herein of the terms such as “substantially,” “about,” “approximately,” and the like.

While the present invention is described herein in detail in relation to specific aspects and embodiments, it is to be understood that this detailed description is only illustrative and exemplary of the present invention and is made merely for purposes of providing a full and enabling disclosure of the present invention and to set forth the best mode of practicing the invention known to the inventors at the time the invention was made. The detailed description set forth herein is illustrative only and is not intended, nor is to be construed, to limit the present invention or otherwise to exclude any such other embodiments, adaptations, variations, modifications, and equivalent arrangements of the present invention. All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other. Also, descriptions of sequences of steps or other actions are described for purposes of providing examples, and not for the purpose of limiting the scope of this disclosure (e.g., where appropriate, steps or actions may be performed in different sequences than described above, and steps and actions may be omitted and/or added). Further, various elements discussed with reference to the various embodiments may be interchanged to create entirely new embodiments coming within the scope of the present invention. The figures are schematic representations and so are not necessarily drawn to scale.

In the specification and drawings, examples of embodiments have been disclosed. The present invention is not limited to such exemplary embodiments. The use of the term “and/or” includes any and all combinations of one or more of the associated listed items (e.g., can refer to elements that are conjunctively present in some embodiments and elements that are disjunctively present in other embodiments), and in some embodiments optionally in combination with other elements not specifically identified by the “and/or” phrase. As non-limiting examples, “A and/or B” can refer in some embodiments to A without B; in some embodiments to B without A; in some embodiments to both A and B; etc.

As used herein, the phrase “at least one” in reference to a list of one or more elements can refer to at least one element selected from any one or more of the elements in the list of elements, but not necessarily including at least one of each and every element specifically listed within the list of elements and not excluding any combinations of elements in the list of elements. In some embodiments, elements may be optionally present other than the elements specifically identified within the list of elements to which the phrase “at least one” refers, whether related or unrelated to those elements specifically identified. As non-limiting examples, “at least one of A and B”; “at least one of A or B”; and/or “at least one of A and/or B” can refer in some embodiments to at least one, optionally including more than one, A, with no B present (and optionally including elements other than B); in some embodiments to at least one, optionally including more than more one, B, with no A present (and optionally including elements other than A); in some embodiments to at least one, optionally including more than one, A, and at least one, optionally including more than one, B (and optionally including other elements); etc.

As used herein, indefinite articles “a” and “an” refer to at least one (“a” and “an” can refer to singular and/or plural element(s)).

Unless otherwise noted, specific terms have been used in a generic and descriptive sense and not for purposes of limitation.

Numerical values provided throughout this disclosure can be approximate, and for each range specified in this disclosure, all values within the range (including end points) and all subranges within the range are also disclosed. Those of ordinary skill in the art will also readily understand that, in different implementations of the features of this disclosure, reasonably different engineering tolerances, precision, and/or accuracy (for example with respect to numerical value(s)) may be applicable and suitable for obtaining the desired result. Those of ordinary skill will accordingly readily understand the meaning, usage, etc. herein of terms such as “substantially,” “about,” “approximately,” and the like. As non-limiting examples, the term “about” can indicate that a numeric value can vary by plus or minus 25%, for example plus or minus 20%, for example plus or minus 15%, for example plus or minus 10%, for example plus or minus 5%, for example plus or minus 4%, for example plus or minus 3%, for example plus or minus 2%, for example plus or minus 1%, for example plus or minus less than 1%, for example plus or minus 0.5%, for example less than plus or minus 0.5%, including all values and subranges therebetween for each of the above ranges. Numerical values provided throughout this disclosure can be approximate, and for each range specified in this disclosure, all values within the range (including end points) and all subranges within the range are also disclosed. Those of ordinary skill in the art will also readily understand that, in different implementations of the features of this disclosure, reasonably different engineering tolerances, precision, and/or accuracy (for example with respect to numerical value(s)) may be applicable and suitable for obtaining the desired result. Those of ordinary skill will accordingly readily understand the meaning, usage, etc. herein of terms such as “substantially,” “about,” “approximately,” and the like. As non-limiting examples, the term “about” can indicate that a numeric value can vary by plus or minus 25%, for example plus or minus 20%, for example plus or minus 15%, for example plus or minus 10%, for example plus or minus 5%, for example plus or minus 4%, for example plus or minus 3%, for example plus or minus 2%, for example plus or minus 1%, for example plus or minus less than 1%, for example plus or minus 0.5%, for example less than plus or minus 0.5%, including all values and subranges therebetween for each of the above ranges.

What is claimed is:

1. A liquid chromatography column oven capable of pre-heating a mobile phase at a semi-preparative and/or a preparative scale, the liquid chromatography column oven comprising:
a housing including one or more walls defining a column oven interior space;
a heat source configured to generate heat, the heat source positioned in the column oven interior space; and
a heat transfer assembly comprising:
at least one heat transfer structure positioned in the column oven interior space formed of a thermally conductive material and in a conductive heat transfer relationship with the heat source, the at least one heat transfer structure including at least one recessed pathway in a surface of the heat transfer structure, and
at least one tubing formed of a thermally conductive material, the tubing comprising:
at least a first portion of an exterior surface of the tubing in a conductive heat transfer relationship with the recessed pathway of the heat transfer structure, wherein the heat source provides heat to the heat transfer structure for transfer to the first portion of the exterior surface of the tubing and to a mobile phase flowing through the tubing, and
at least a second portion of the exterior surface of the tubing in a conductive heat transfer relationship with the heat source, wherein the heat source provides heat to the second portion of the exterior surface of the tubing for transfer to the mobile phase flowing through the tubing.

2. The liquid chromatography column oven of claim 1, further comprising a heat transfer material interposed between at least a portion of the exterior surface of the tubing and the recessed pathway of the heat transfer structure and/or between at least a portion of the exterior surface of the tubing and the heat source.

3. The liquid chromatography column oven of claim 1, wherein the heat transfer structure comprises at least one heat transfer plate formed of a thermally conductive material having opposite surfaces and including the at least one recessed pathway in one of the opposite surfaces of the heat transfer plate.

4. The liquid chromatography column oven of claim 3, wherein:
the heat source includes a heat source base configured to generate heat, the heat source base having opposite first and second surfaces and a plurality of fins extending from one of the opposite surfaces of the heat source base of the heat source, and
the heat transfer plate includes a plurality of holes in the form of slots configured to engage at least some of the plurality of fins and position the second portion of the exterior surface of the tubing in a conductive heat transfer relationship with at least a portion of the heat source base.

5. The liquid chromatography column oven of claim 1, comprising:
a sensor configured to provide a signal indicative of temperature in the column oven interior space; and
a computer configured to control, by increasing or decreasing heat generated by the heat source, in response to an input, the temperature in the column oven interior space, wherein the input comprises the signal from the sensor.

6. The liquid chromatography column oven of claim 5, comprising a fan in the column oven interior space configured for circulating heat generated by the heat source through the column oven interior space.

7. The liquid chromatography column oven of claim 6, comprising a column in the column oven interior space configured for liquid chromatography, the column including a column inlet and a column outlet,
wherein the tubing defines a mobile phase flow path and includes a tubing inlet in fluid communication with a mobile phase source and a tubing outlet in fluid communication with the column inlet for directing a mobile phase from the tubing into the column.

8. The liquid chromatography column oven of claim 7, wherein:
the column includes a stationary phase, and
the heat source is configured to receive an electric current and to convert the electric current to heat capable of conductively heating a mobile phase in the tubing and, in combination with the fan, capable of convectively heating the column and/or the stationary phase of the column.

9. The liquid chromatography column oven of claim 1, wherein the at least one tubing is configured with a surface area sufficient to facilitate heat transfer through the tubing to pre-heat a mobile phase flowing through the tubing at a mobile phase flow rate ranging from about 4 mL/minute to about 40 mL/minute.

10. The liquid chromatography column oven of claim 1, wherein the at least one tubing is configured with a surface area sufficient to facilitate heat transfer through the tubing to pre-heat a mobile phase flowing through the tubing at a mobile phase flow rate ranging from about 15 mL/minute to about 40 mL/minute.

11. The liquid chromatography column oven of claim 1, wherein the at least one tubing is configured with a surface area sufficient to facilitate heat transfer through the tubing to pre-heat a mobile phase flowing through the tubing at a mobile phase flow rate ranging from about 4 mL/minute to about 14 mL/minute.

12. The liquid chromatography column oven of claim 1, wherein:
the at least one heat transfer structure comprises a second recessed pathway on the same surface of the at least one heat transfer structure as the first recessed pathway,
the at least one tubing is a first tubing having a first tubing exterior surface, the first tubing configured with a surface area sufficient to facilitate heat transfer through the tubing to pre-heat a mobile phase flowing through the tubing at a first mobile phase flow rate,
the heat transfer assembly comprises a second tubing formed of a thermally conductive material, the second tubing configured with a surface area sufficient to facilitate heat transfer through the tubing to pre-heat a mobile phase flowing through the tubing at a second mobile phase flow rate that is different from the first mobile phase flow rate, the second tubing comprising:
at least a first portion of a second tubing exterior surface of the second tubing in a conductive heat transfer relationship with the second recessed pathway of the at least one heat transfer structure, wherein the heat source provides heat to the at least one heat transfer structure for transfer to the first portion of the second tubing exterior surface of the second tubing and to a mobile phase flowing through the second tubing, and
at least a second portion of the second tubing exterior surface of the second tubing in a conductive heat transfer relationship with the heat source, wherein the heat source provides heat to the second portion of the second tubing exterior surface of the second tubing for transfer to the mobile phase flowing through the second tubing.

13. The liquid chromatography column oven of claim 12, wherein at least one of the first tubing and the second tubing is configured with a surface area sufficient to facilitate heat transfer through the tubing to pre-heat a mobile phase flowing through the tubing at a mobile phase flow rate ranging from about 4 mL/minute to about 14 mL/minute and the other of the first tubing and the second tubing is configured with a surface area sufficient to facilitate heat transfer through the tubing to pre-heat a mobile phase flowing through the tubing at a mobile phase flow rate ranging from about 15 mL/minute to about 40 mL/minute.

14. The liquid chromatography column oven of claim 1, wherein:
the at least one heat transfer structure is a first heat transfer structure,
the heat transfer assembly includes a second heat transfer structure formed of a thermally conductive material and in a conductive heat transfer relationship with the heat source, the second heat transfer structure comprising at least one recessed pathway in a surface of the second heat transfer structure,
at least a third portion of the exterior surface of the tubing is in a conductive heat transfer relationship with the at least one recessed pathway in the surface of the second heat transfer structure, wherein the heat source provides heat to the second heat transfer structure for transfer to the third portion of the exterior surface of the tubing and to the mobile phase flowing through the tubing, and
at least a fourth portion of the exterior surface of the tubing is in a conductive heat transfer relationship with the heat source, wherein the heat source provides heat to the fourth portion of the exterior surface of the tubing for transfer to the mobile phase flowing through the tubing.

15. The liquid chromatography column oven of claim 1, wherein:
the at least one heat transfer structure is a first heat transfer structure,
the first heat transfer structure comprises a second recessed pathway on the same surface of the first heat transfer structure as the first recessed pathway,
the at least one tubing is a first tubing having a first tubing exterior surface, the first tubing configured with a surface area sufficient to facilitate heat transfer through the first tubing to pre-heat a mobile phase flowing through the tubing at a first mobile phase flow rate,
the heat transfer assembly comprises a second tubing formed of a thermally conductive material, the second tubing configured with a surface area sufficient to facilitate heat transfer through the second tubing to pre-heat a mobile phase flowing through the tubing at a second mobile phase flow rate that is different from the first mobile phase flow rate, the second tubing comprising:
at least a first portion of a second tubing exterior surface of the second tubing in a conductive heat transfer relationship with the second recessed pathway of the first heat transfer structure, wherein the heat source provides heat to the first heat transfer structure for transfer to the first portion of the second tubing exterior surface of the second tubing and to a mobile phase flowing through the second tubing, and
at least a second portion of the second tubing exterior surface of the second tubing in a conductive heat transfer relationship with the heat source, wherein the heat source provides heat to the second portion of the second tubing exterior surface of the second tubing for transfer to the mobile phase flowing through the second tubing,
the heat transfer assembly includes a second heat transfer structure formed of a thermally conductive material and in a conductive heat transfer relationship with the heat source, the second heat transfer structure comprising at least a third recessed pathway in a surface of the second heat transfer structure,
at least a third portion of the exterior surface of the first tubing is in a conductive heat transfer relationship with the third recessed pathway in the surface of the second heat transfer structure, wherein the heat source provides heat to the second heat transfer structure for transfer to the third portion of the exterior surface of the first tubing and to the mobile phase flowing through the first tubing, and
at least a fourth portion of the exterior surface of the first tubing is in a conductive heat transfer relationship with the heat source, wherein the heat source provides heat to the fourth portion of the exterior surface of the first tubing for transfer to the mobile phase flowing through the first tubing.

16. A liquid chromatography system for pre-heating a mobile phase at a semi-preparative and/or a preparative scale, comprising:
a liquid chromatography column oven comprising one or more walls defining a column oven interior space;
a column in the column oven interior space configured for liquid chromatography and including a column inlet and a column outlet, the column defining at least a portion of a mobile phase flow path;
a mobile phase supply system for supplying a mobile phase; and
a detector in fluid communication with the column outlet for receiving the mobile phase from the column of the liquid chromatography column oven and detecting a component when present in the mobile phase,
wherein the liquid chromatography column oven further comprises:
a heat source configured to generate heat; and
a heat transfer assembly comprising:
at least one heat transfer structure positioned in the column oven interior space formed of a thermally conductive material and in a conductive heat transfer relationship with the heat source, the at least one heat transfer structure including at least one recessed pathway in a surface of the heat transfer structure, and
at least one tubing formed of a thermally conductive material and defining at least another portion of the mobile phase flow path,
the tubing comprising a tubing inlet capable of being in fluid communication with the mobile phase supply system for receiving the mobile phase from the mobile phase supply system and a tubing outlet capable of being in fluid communication with the column inlet for directing the mobile phase from the tubing into the column,
at least a first portion of an exterior surface of the tubing in a conductive heat transfer relationship with the recessed pathway of the heat transfer structure, wherein the heat source provides heat to the heat transfer structure for transfer to the first portion of the exterior surface of the tubing and to the mobile phase flowing through the tubing, and
at least a second portion of the exterior surface of the tubing in a conductive heat transfer relationship with the heat source, wherein the heat source provides heat to the second portion of the exterior surface of the tubing for transfer to the mobile phase flowing through the tubing.

17. The liquid chromatography system of claim 16, comprising a sample injection valve between the mobile phase supply system and the liquid chromatography column oven for injecting a sample into a mobile phase supplied from the mobile phase supply system to the column of the liquid chromatography column oven.

18. The liquid chromatography system of claim 16, further comprising a heat transfer material interposed between at least a portion of the exterior surface of the tubing and the recessed pathway of the heat transfer structure and/or between at least a portion of the exterior surface of the tubing and the heat source.

19. The liquid chromatography system of claim 16, wherein:
the heat transfer structure comprises at least one heat transfer plate formed of a thermally conductive material having opposite surfaces and including the at least one recessed pathway in one of the opposite surfaces of the heat transfer plate.

20. The liquid chromatography system of claim 19, wherein:
the heat source includes a heat source base configured to generate heat, the heat source base having opposite first and second surfaces and a plurality of fins extending from one of the opposite surfaces of the heat source base of the heat source, and
the heat transfer plate includes a plurality of holes in the form of slots configured to engage at least some of the plurality of fins and position the second portion of the exterior surface of the tubing in a conductive heat transfer relationship with at least a portion of the heat source base.

21. The liquid chromatography system of claim 16, comprising:
a sensor configured to provide a signal indicative of temperature in the column oven interior space; and
a computer configured to control, by increasing or decreasing heat generated by the heat source, in response to an input, the temperature in the column oven interior space, wherein the input comprises the signal from the sensor.

22. The liquid chromatography system of claim 21, comprising a fan in the column oven interior space configured for circulating heat generated by the heat source through the column oven interior space.

23. The liquid chromatography system of claim 22, wherein the heat source is configured to receive an electric current and to convert the electric current to heat capable of conductively heating a mobile phase in the tubing and, in combination with the fan, capable of convectively heating the column and/or the stationary phase of the column.

24. The liquid chromatography system of claim 16, wherein the at least one tubing is configured with a surface area sufficient to facilitate heat transfer through the tubing to pre-heat a mobile phase flowing through the tubing at a mobile phase flow rate ranging from about 4 mL/minute to about 40 mL/minute.

25. The liquid chromatography system of claim 16, wherein the at least one tubing is configured with a surface area sufficient to facilitate heat transfer through the tubing to pre-heat a mobile phase flowing through the tubing at a mobile phase flow rate ranging from about 15 mL/minute to about 40 mL/minute.

26. The liquid chromatography system of claim 16, wherein the at least one tubing is configured with a surface area sufficient to facilitate heat transfer through the tubing to pre-heat a mobile phase flowing through the tubing at a mobile phase flow rate ranging from about 4 mL/minute to about 14 mL/minute.

27. The liquid chromatography system of claim 16, wherein:
the at least one heat transfer structure comprises a second recessed pathway on the same surface of the at least one heat transfer structure as the first recessed pathway,
the at least one tubing is a first tubing having a first tubing exterior surface, the first tubing configured with a surface area sufficient to facilitate heat transfer through the tubing to pre-heat a mobile phase flowing through the tubing at a first mobile phase flow rate,
the heat transfer assembly comprises a second tubing formed of a thermally conductive material and defining at least a portion of another mobile phase flow path through the second tubing, the second tubing configured with a surface area sufficient to facilitate heat transfer through the second tubing to pre-heat a mobile phase flowing through the second tubing at a second mobile phase flow rate that is different from the first mobile phase flow rate,
the second tubing comprising:
a second tubing inlet capable of being in fluid communication with the mobile phase supply system for receiving the mobile phase from the mobile phase supply system and a second tubing outlet capable of being in fluid communication with the column inlet for directing the mobile phase from the second tubing into the column,
at least a first portion of a second tubing exterior surface of the second tubing in a conductive heat transfer relationship with the second recessed pathway of the at least one heat transfer structure, wherein the heat source provides heat to the at least one heat transfer structure for transfer to the first portion of the second tubing exterior surface of the second tubing and to a mobile phase flowing through the second tubing, and
at least a second portion of the second tubing exterior surface of the second tubing in a conductive heat transfer relationship with the heat source, wherein the heat source provides heat to the second portion of the second tubing exterior surface of the second tubing for transfer to the mobile phase flowing through the second tubing.

28. The liquid chromatography system of claim 27, wherein at least one of the first tubing and the second tubing is configured with a surface area sufficient to facilitate heat transfer through the tubing to pre-heat a mobile phase flowing through the tubing at a mobile phase flow rate ranging from about 4 mL/minute to about 14 mL/minute and the other of the first tubing and the second tubing is configured with a surface area sufficient to facilitate heat transfer through the tubing to pre-heat a mobile phase flowing through the tubing at a mobile phase flow rate ranging from about 15 mL/minute to about 40 mL/minute.

29. The liquid chromatography system of claim 16, wherein:
the at least one heat transfer structure is a first heat transfer structure,
the heat transfer assembly includes a second heat transfer structure formed of a thermally conductive material and in a conductive heat transfer relationship with the heat source, the second heat transfer structure comprising at least one recessed pathway in a surface of the second heat transfer structure,
at least a third portion of the exterior surface of the tubing is in a conductive heat transfer relationship with the at least one recessed pathway in the surface of the second heat transfer structure, wherein the heat source provides heat to the second heat transfer structure for transfer to the third portion of the exterior surface of the tubing and to the mobile phase flowing through the tubing, and
at least a fourth portion of the exterior surface of the tubing is in a conductive heat transfer relationship with the heat source, wherein the heat source provides heat to the fourth portion of the exterior surface of the tubing for transfer to the mobile phase flowing through the tubing.

30. The liquid chromatography system of claim 16, wherein:
the at least one heat transfer structure is a first heat transfer structure,
the first heat transfer structure comprises a second recessed pathway on the same surface of the first heat transfer structure as the first recessed pathway,
the at least one tubing is a first tubing having a first tubing exterior surface, the first tubing configured with a surface area sufficient to facilitate heat transfer through the first tubing to pre-heat a mobile phase flowing through the tubing at a first mobile phase flow rate,
the heat transfer assembly comprises a second tubing formed of a thermally conductive material and defining at least a portion of another mobile phase flow path through the second tubing, the second tubing configured with a surface area sufficient to facilitate heat transfer through the second tubing to pre-heat a mobile phase flowing through the second tubing at a second mobile phase flow rate that is different from the first mobile phase flow rate,
the second tubing comprising:
a second tubing inlet capable of being in fluid communication with the mobile phase supply system for receiving the mobile phase from the mobile phase supply system and a second tubing outlet capable of being in fluid communication with the column inlet for directing the mobile phase from the second tubing into the column,
at least a first portion of a second tubing exterior surface of the second tubing in a conductive heat transfer relationship with the second recessed pathway of the first heat transfer structure, wherein the heat source provides heat to the first heat transfer structure for transfer to the first portion of the second tubing exterior surface of the second tubing and to the mobile phase flowing through the second tubing, and
at least a second portion of the second tubing exterior surface of the second tubing in a conductive heat transfer relationship with the heat source, wherein the heat source provides heat to the second portion of the second tubing exterior surface of the second tubing for transfer to the mobile phase flowing through the second tubing,
the heat transfer assembly includes a second heat transfer structure formed of a thermally conductive material and in a conductive heat transfer relationship with the heat source, the second heat transfer structure comprising at least a third recessed pathway in a surface of the second heat transfer structure,
at least a third portion of the exterior surface of the first tubing is in a conductive heat transfer relationship with the third recessed pathway in the surface of the second heat transfer structure, wherein the heat source provides heat to the second heat transfer structure for transfer to the third portion of the exterior surface of the first tubing and to the mobile phase flowing through the first tubing, and
at least a fourth portion of the exterior surface of the first tubing is in a conductive heat transfer relationship with the heat source, wherein the heat source provides heat to the fourth portion of the exterior surface of the first tubing for transfer to the mobile phase flowing through the first tubing.

31. A method for heating a mobile phase in a liquid chromatography column oven at a semi-preparative and/or a preparative scale, the method comprising:
generating heat using a heat source positioned in an interior space of a column oven; and
heating a mobile phase flowing through a tubing located in the interior space of the column oven, the tubing formed of a thermally conductive material, having an exterior surface, and defining at least a portion of a mobile phase flow path,
wherein a portion of the exterior surface of the tubing is in a conductive heat transfer relationship with a recessed pathway of a heat transfer structure formed of a thermally conductive material located in the interior of the column oven, the heat transfer structure is in a conductive heat transfer relationship with the heat source, and heat generated by the heat source heats the heat transfer structure, the portion of the exterior surface of the tubing in the conductive heat transfer relationship with the heat transfer structure, and the mobile phase flowing through the tubing; and
wherein another portion of the exterior surface of the tubing is in a conductive heat transfer relationship with the heat source, and heat generated by the heat source heats the another portion of the exterior surface of the tubing in a conductive heat transfer relationship with the heat source and the mobile phase flowing through the tubing.

32. The method of claim 31, comprising:
sending electric energy to the heat source positioned in the interior space of the column oven to generate thermal energy; and
conductively heating the mobile phase flowing through the tubing located in the interior space of the column oven using the generated thermal energy.

33. The method of claim 32, comprising heating the interior space of the column oven using heat generated by the heat source.

34. The method of claim 33, wherein a temperature of heat generated by the heat source is higher than a temperature of the interior space of the column oven.

35. The method of claim 33, wherein heating the interior space of the column oven using heat generated by the heat source comprises:
heating air present in the interior space of the column oven using heat generated by the heat source; and
circulating the heated air to convectively heat the interior space of the column oven.

36. The method of claim 33, comprising determining, during the generating heat using the heat source, and from at least one signal, whether a predetermined temperature of the interior space of the column oven has been reached; and adjusting heat output of the heat source based on the determined temperature of the interior space of the column oven.

37. The method of claim 36, comprising determining, during the generating heat using the heat source, and from the at least one signal, that the predetermined temperature of the interior space of the column oven has been reached; and maintaining heat output of the heat source.

38. The method of claim 37, comprising injecting a sample into the mobile phase after the predetermined temperature of the interior space of the column oven has been reached.

39. The method of claim 37, comprising determining, during the heating of the mobile phase, and from at least another signal, that a predetermined pressure of the mobile phase has been reached.

40. The method of claim 39, comprising:
determining, during the heating of the mobile phase, and from the at least another signal, that the predetermined pressure of the mobile phase has been reached; and
injecting a sample into the mobile phase.

41. The method of claim 40, wherein:
the column oven includes a column configured for liquid chromatography having a column inlet and a column outlet, the column defining at least another portion of the mobile phase flow path; and
the tubing comprises a tubing inlet in fluid communication with a mobile phase supply system and a tubing outlet in fluid communication with the column inlet,
the method comprising:
directing the mobile phase from the mobile phase supply system to the tubing inlet into the tubing and through the tubing to the tubing outlet, from the tubing outlet to the column inlet, and through the column to the column outlet; and
injecting a sample into the mobile phase before the tubing inlet.

42. The method of claim 31, wherein the tubing is configured with a surface area sufficient to facilitate heat transfer through the tubing to heat the mobile phase flowing through the tubing at a mobile phase flow rate ranging from about 4 mL/minute to about 40 mL/minute.

43. The method of claim 31, wherein the tubing is configured with a surface area sufficient to facilitate heat transfer through the tubing to heat the mobile phase flowing through the tubing at a mobile phase flow rate ranging from about 15 mL/minute to about 40 mL/minute.

44. The method of claim 31, wherein the tubing is configured with a surface area sufficient to facilitate heat transfer through the tubing to heat the mobile phase flowing through the tubing at a mobile phase flow rate ranging from about 4 mL/minute to about 14 mL/minute.

45. A method for conducting liquid chromatography at a semi-preparative and/or a preparative scale, the method comprising:
generating heat using a heat source positioned in an interior space of a column oven;
heating a mobile phase flowing through a tubing located in the interior space of the column oven,
wherein the tubing is formed of a thermally conductive material and comprises an exterior surface, a tubing inlet in fluid communication with a mobile phase supply system and a tubing outlet in fluid communication with a column inlet of a chromatography column located in the interior space of the column oven, the tubing defining at least a portion of a mobile phase flow path,
wherein a portion of the exterior surface of the tubing is in a conductive heat transfer relationship with a recessed pathway of a heat transfer structure formed of a thermally conductive material located in the interior of the column oven, the heat transfer structure is in a conductive heat transfer relationship with the heat source, and heat generated by the heat source heats the heat transfer structure, the portion of the exterior surface of the tubing in the conductive heat transfer relationship with the heat transfer structure, and the mobile phase flowing through the tubing; and
wherein another portion of the exterior surface of the tubing is in a conductive heat transfer relationship with the heat source, and heat generated by the heat source heats the another portion of the exterior surface of the tubing in a conductive heat transfer relationship with the heat source and the mobile phase flowing through the tubing;
directing the mobile phase from the tubing outlet to the column inlet, through the column to a column outlet, and from the column outlet to a detector capable of determining components of a sample carried by the mobile phase;
determining, during the generating heat using the heat source, and from at least one signal, that a predetermined temperature of the interior space of the column oven has been reached;
injecting a sample into the mobile phase after the predetermined temperature of the interior space of the column oven has been reached; and
detecting a component when present in the mobile phase as the mobile phase passes through the detector.
